(19) United States
(12) Patent Application Publication
(10) Pub. No.: US 2018/0246762 A1
(43) Pub. Date: Aug. 30, 2018

(54) RUNTIME PROCESSOR OPTIMIZATION

(71) Applicant: Intel Corporation, Santa Clara, CA (US)

(72) Inventors: Stephen J. Tarsa, Cambridge, MA (US); Gautham N. Chinya, Portland, OR (US); Gokce Keskin, Sunnyvale, CA (US); Hong Wang, Santa Clara, CA (US); Karthik Sankaranarayanan, Tigard, OR (US)

(73) Assignee: Intel Corporation, Santa Clara, CA (US)

(21) Appl. No.: 15/444,390

(22) Filed: Feb. 28, 2017

(51) Int. Cl. G06F 9/50

(52) U.S. Cl. CPC G06F 9/505; G06F 2209/501; G06F 9/5094

(57) ABSTRACT

In one embodiment, a processor comprises a processor optimization unit. The processor optimization unit is to collect runtime information associated with a computing device, wherein the runtime information comprises information indicating a performance of the computing device during program execution. The processor optimization unit is further to receive runtime optimization information for the computing device, wherein the runtime optimization information comprises information associated with one or more runtime optimizations for the computing device, and wherein the runtime optimization information is determined based on an analysis of the collected runtime information. The processor optimization unit is further to perform the one or more runtime optimizations for the computing device based on the runtime optimization information.

### FIELD OF THE SPECIFICATION

This disclosure relates in general to the field of computer processing, and more particularly, though not exclusively, to runtime processor optimizations.

### BACKGROUND

The demand for high-performance and power-efficient computer processors is continuously increasing. Existing processor architectures, however, are unable to efficiently adapt to actual workload patterns encountered at runtime, thus limiting their ability to be dynamically optimized to achieve maximum performance and/or power efficiency.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates a schematic diagram of an example computing environment.

FIGS. 2A-C illustrate an example embodiment of on-chip processor optimization.

FIGS. 3A-C illustrate performance metrics for example embodiments of processor workload phase learning.

FIG. 4 illustrates a flowchart for an example embodiment of on-chip processor optimization.

FIG. 5 illustrates a block diagram for an example embodiment of cloud-based processor optimization.

FIG. 6 illustrates an example use case of cloud-based processor optimization.

FIG. 7 illustrates an example embodiment of cloud-based processor optimization using a map-reduce implementation.

FIG. 8 illustrates a flowchart for an example embodiment of on-chip processor optimization.

FIG. 9 illustrates a flowchart for an example embodiment of runtime processor optimization.

FIG. 10A is a block diagram illustrating both an exemplary in-order pipeline and an exemplary register renaming, out-of-order issue/execution pipeline according to embodiments of the invention.

FIG. 10B is a block diagram illustrating both an exemplary embodiment of an in-order architecture core and an exemplary register renaming, out-of-order issue/execution architecture core to be included in a processor according to embodiments of the invention.

FIG. 11 is a block diagram of a processor that may have more than one core, may have an integrated memory controller, and may have integrated graphics according to embodiments of the invention.

FIGS. 12-14 are block diagrams of exemplary computer architectures.

FIG. 15 is a block diagram contrasting the use of a software instruction converter to convert binary instructions in a source instruction set to binary instructions in a target instruction set according to embodiments of the invention.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Example embodiments of this disclosure will now be described with more particular reference to the attached FIGURES.

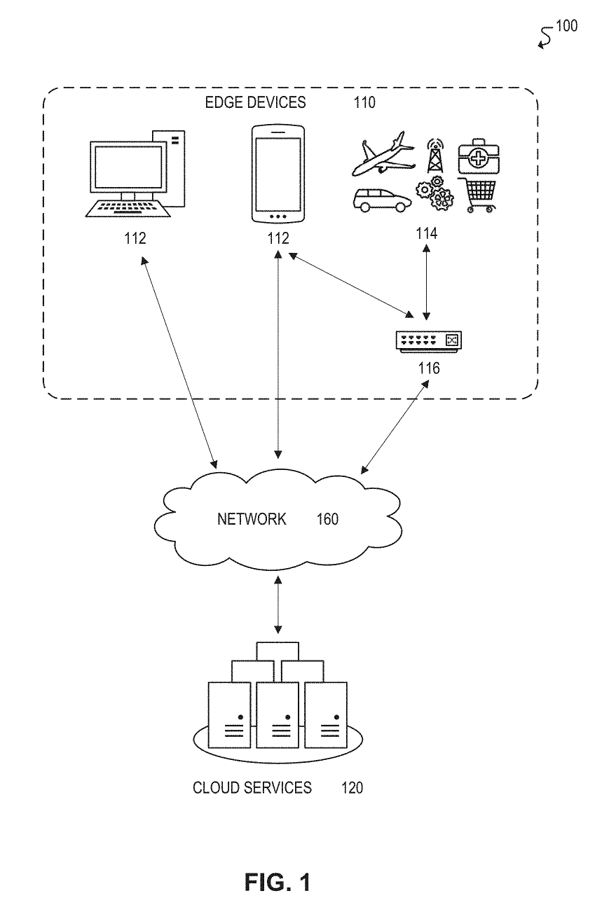

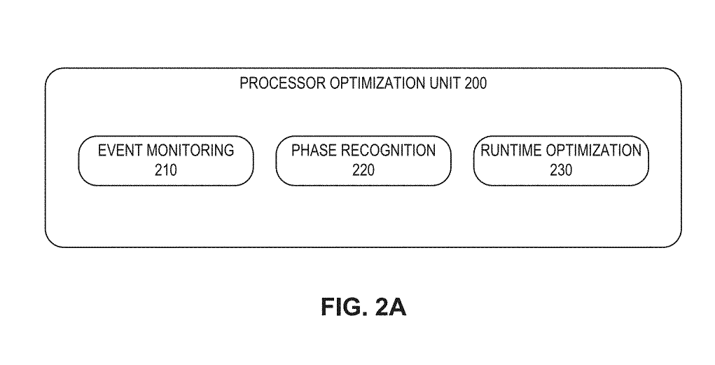

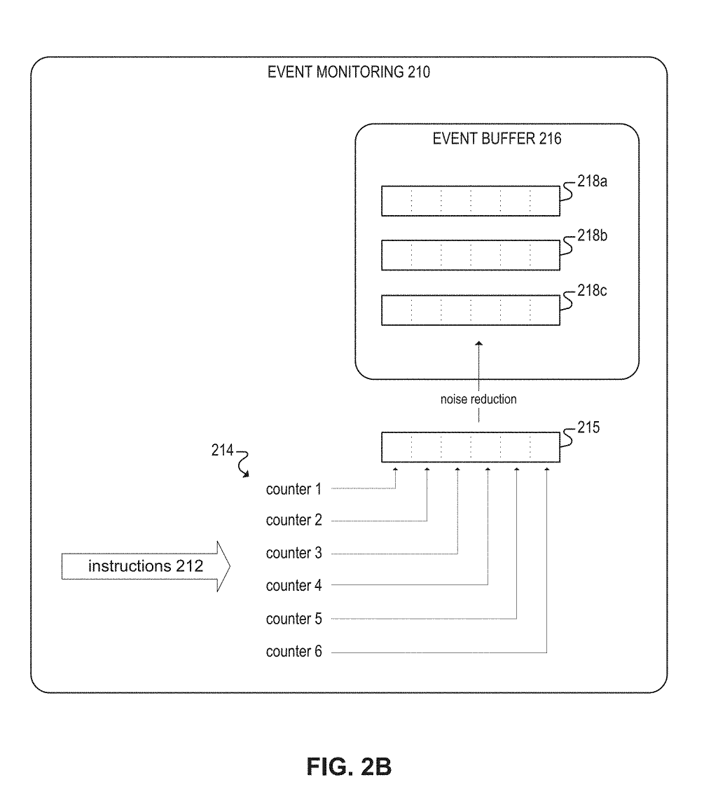

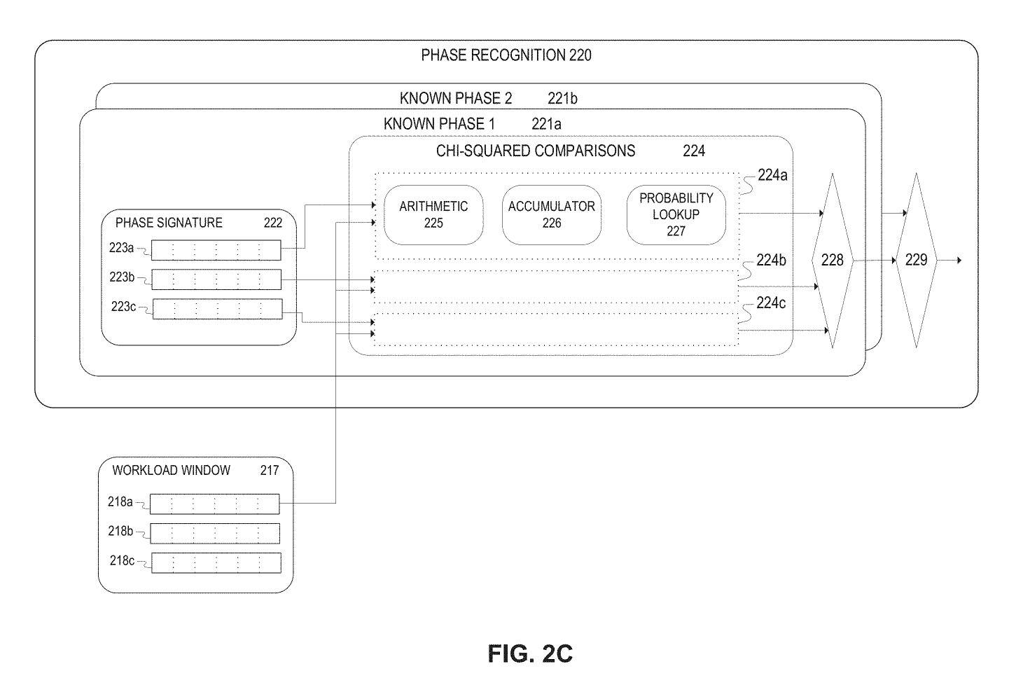

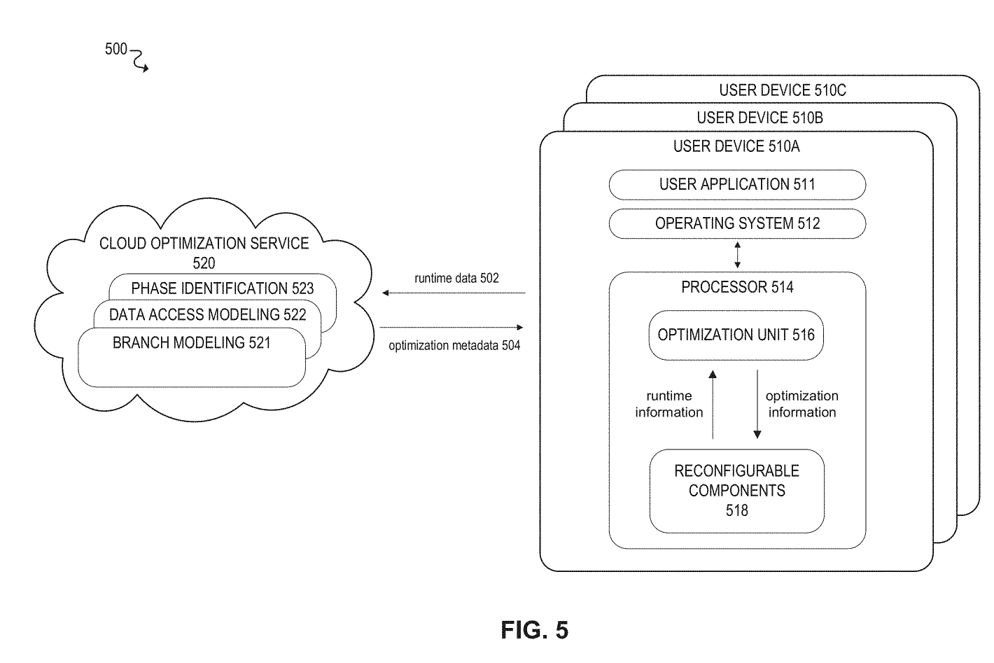

FIG. 1 illustrates a schematic diagram of an example computing system or environment 100. In some embodiments, system 100 and/or its underlying components may be implemented with functionality described throughout this disclosure for performing runtime-based processor optimizations. For example, the various components of system 100 (e.g., edge devices 110, cloud services 120, communication networks 150) may include a wide range of devices powered by processors, controllers, and/or other types of electronic circuitry or logic. The demand for high-performance and power-efficient computer processors is continuously increasing. Existing processor architectures, however, are unable to efficiently adapt to actual workload patterns encountered at runtime, thus limiting their ability to be dynamically optimized to achieve maximum performance and/or power efficiency. Accordingly, this disclosure describes various embodiments for performing runtime processor optimizations, including on-chip optimizations and cloud-based optimizations. Moreover, these runtime-based processor optimizations can be implemented on any of the processing devices in system 100. For example, processing devices in system 100 could be implemented using the on-chip processor optimizations described in connection with FIGS. 2-4, the cloud-based processor optimizations described in connection with FIGS. 5-8, or a combination of both on-chip and cloud-based processor optimizations. For example, in some embodiments, a cloud-based served may perform runtime analyses to discover optimization policies for a processing device, and the processing device may include reconfigurable circuit mechanisms to implement any optimizations that are identified (e.g., optimizations identified by the cloud-based service or “on-chip” by the processing device).

The various components in the illustrated example of computing system 100 will now be discussed further below.

Edge devices 110 may include any equipment and/or devices deployed or connected near the “edge” of a communication system 100. In the illustrated embodiment, edge devices 110 include end-user devices 112 (e.g., desktops, laptops, mobile devices), Internet-of-Things (IoT) devices 114, and gateways and/or routers 116, among other examples. Edge devices 110 may communicate with each other and/or with other remote networks and services (e.g., cloud services 120) through one or more networks and/or communication protocols, such as communication network 150. Moreover, in some embodiments, certain edge devices 110 may include the processor optimization functionality described throughout this disclosure.

End-user devices 112 may include any device that enables or facilitates user interaction with computing system 100, including, for example, desktop computers, laptops, tablets, mobile phones and other mobile devices, and wearable devices (e.g., smart watches, smart glasses, headsets), among other examples.

IoT devices 114 may include any device capable of communicating and/or participating in an Internet-of-Things (IoT) system or network. IoT systems may refer to new or improved ad-hoc systems and networks composed of multiple different devices (e.g., IoT devices 114) interoperating and synergizing for a particular application or use case. Such ad-hoc systems are emerging as more and more products and equipment evolve to become “smart,” meaning they are controlled or monitored by computer processors and are capable of communicating with other devices. For example, an IoT device 114 may include a computer processor and/or communication interface to allow interoperation with other components of system 100, such as with cloud services 120 and/or other edge devices 110. IoT devices 114 may be “greenfield” devices that are developed with IoT capabilities from the ground-up, or “brownfield” devices that are created by integrating IoT capabilities into existing legacy devices that were initially developed without IoT capabilities. For example, in some cases, IoT devices 114 may be built from sensors and communication modules integrated in or attached to “things,” such as equipment, toys, tools, vehicles, living things (e.g., plants, animals, humans), and so forth. Alternatively, or additionally, certain IoT devices 114 may rely on intermediary components, such as edge gateways or routers 116, to communicate with the various components of system 100.

IoT devices 114 may include various types of sensors for monitoring, detecting, measuring, and generating sensor data and signals associated with characteristics of their environment. For instance, a given sensor may be configured to detect one or more respective characteristics, such as movement, weight, physical contact, temperature, wind, noise, light, position, humidity, radiation, liquid, specific chemical compounds, battery life, wireless signals, computer communications, and bandwidth, among other examples. Sensors can include physical sensors (e.g., physical monitoring components) and virtual sensors (e.g., software-based monitoring components). IoT devices 114 may also include actuators to perform various actions in their respective environments. For example, an actuator may be used to selectively activate certain functionality, such as toggling the power or operation of a security system (e.g., alarm, camera, locks) or household appliance (e.g., audio system, lighting, HVAC appliances, garage doors), among other examples.

Indeed, this disclosure contemplates use of a potentially limitless universe of IoT devices 114 and associated sensors/actuators. IoT devices 114 may include, for example, any type of equipment and/or devices associated with any type of system 100 and/or industry, including transportation (e.g., automobile, airlines), industrial manufacturing, energy (e.g., power plants), telecommunications (e.g., Internet, cellular, and television service providers), medical (e.g., healthcare, pharmaceutical), food processing, and/or retail industries, among others. In the transportation industry, for example, IoT devices 114 may include equipment and devices associated with aircrafts, automobiles, or vessels, such as navigation systems, autonomous flight or driving systems, traffic sensors and controllers, and/or any internal mechanical or electrical components that are monitored by sensors (e.g., engines). IoT devices 114 may also include equipment, devices, and/or infrastructure associated with industrial manufacturing and production, shipping (e.g., cargo tracking), communications networks (e.g., gateways, routers, servers, cellular towers), server farms, electrical power plants, wind farms, oil and gas pipelines, water treatment and distribution, wastewater collection and treatment, and weather monitoring (e.g., temperature, wind, and humidity sensors), among other examples. IoT devices 114 may also include, for example, any type of “smart” device or system, such as smart entertainment systems (e.g., televisions, audio systems, videogame systems), smart household or office appliances (e.g., heat-ventilation-air-conditioning (HVAC) appliances, refrigerators, washers and dryers, coffee brewers), power control systems (e.g., automatic electricity, light, and HVAC controls), security systems (e.g., alarms, locks, cameras, motion detectors, fingerprint scanners, facial recognition systems), and other home automation systems, among other examples. IoT devices 114 can be statically located, such as mounted on a building, wall, floor, ground, lamppost, sign, water tower, or any other fixed or static structure. IoT devices 114 can also be mobile, such as devices in vehicles or aircrafts, drones, packages (e.g., for tracking cargo), mobile devices, and wearable devices, among other examples. Moreover, an IoT device 114 can also be any type of edge device 110, including end-user devices 112 and edge gateways and routers 116.

Edge gateways and/or routers 116 may be used to facilitate communication to and from edge devices 110. For example, gateways 116 may provide communication capabilities to existing legacy devices that were initially developed without any such capabilities (e.g., “brownfield” IoT devices). Gateways 116 can also be utilized to extend the geographical reach of edge devices 110 with short-range, proprietary, or otherwise limited communication capabilities, such as IoT devices 114 with Bluetooth or ZigBee communication capabilities. For example, gateways 116 can serve as intermediaries between IoT devices 114 and remote networks or services, by providing a front-haul to the IoT devices 114 using their native communication capabilities (e.g., Bluetooth, ZigBee), and providing a back-haul to other networks 150 and/or cloud services 120 using another wired or wireless communication medium (e.g., Ethernet, Wi-Fi, cellular). In some embodiments, a gateway 116 may be implemented by a dedicated gateway device, or by a general purpose device, such as another IoT device 114, end-user device 112, or other type of edge device 110.

In some instances, gateways 116 may also implement certain network management and/or application functionality (e.g., IoT management and/or IoT application functionality for IoT devices 114), either separately or in conjunction with other components, such as cloud services 120 and/or other edge devices 110. For example, in some embodiments, configuration parameters and/or application logic may be pushed or pulled to or from a gateway device 116, allowing IoT devices 114 (or other edge devices 110) within range or proximity of the gateway 116 to be configured for a particular IoT application or use case.

Cloud services 120 may include services that are hosted remotely over a network 150, or in the “cloud.” In some embodiments, for example, cloud services 120 may be remotely hosted on servers in datacenter (e.g., application servers or database servers). Cloud services 120 may include any services that can be utilized by or for edge devices 110, including but not limited to, data storage, computational services (e.g., data analytics, searching, diagnostics and fault management), security services (e.g., surveillance, alarms, user authentication), mapping and navigation, geolocation services, network or infrastructure management, IoT application and management services, payment processing, audio and video streaming, messaging, social networking, news, and weather, among other examples. Moreover, in some embodiments, certain cloud services 120 may include the processor optimization functionality described throughout this disclosure.

Network 150 may be used to facilitate communication between the components of computing system 100. For example, edge devices 110, such as end-user devices 112 and IoT devices 114, may use network 150 to communicate with each other and/or access one or more remote cloud services 120. Network 150 may include any number or type of communication networks, including, for example, local area networks, wide area networks, public networks, the Internet, cellular networks, Wi-Fi networks, short-range networks (e.g., Bluetooth or ZigBee), and/or any other wired or wireless networks or communication mediums.

Any, all, or some of the computing devices of system 100 may be adapted to execute any operating system, including Linux or other UNIX-based operating systems, Microsoft Windows, Windows Server, MacOS, Apple iOS, Google Android, or any customized and/or proprietary operating system, along with virtual machines adapted to virtualize execution of a particular operating system.

While FIG. 1 is described as containing or being associated with a plurality of elements, not all elements illustrated within system 100 of FIG. 1 may be utilized in each alternative implementation of the present disclosure. Additionally, one or more of the elements described in connection with the examples of FIG. 1 may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

On-Chip Processor Optimization

FIGS. 2A-C illustrate an example embodiment of on-chip processor optimization. In general, computer processors (e.g., central processing units (CPUs), microprocessors, microcontrollers, and other microarchitectures) exhibit stable and repetitive patterns even for workloads at finely-grained scales, such as workloads on the order of tens-of-thousands of instructions. Certain processor designs, however, may be incapable of adapting to these finely-grained workload patterns. For example, in some cases, a processor may operate according to static policies determined at the design and development stage. A processor may also allow certain operational aspects to be manually configured. In some cases, the design or configuration of a processor may be derived from analyses performed offline or off-chip, such as by analyzing pooled statistics for millions of instructions. These approaches alone, however, provide no ability to dynamically adapt to actual workload patterns encountered at runtime. These approaches are also unable to adapt to workload patterns that occur at fine-grained scales (e.g., every tens-of-thousands of instructions).

The primary obstacle to performing effective processor optimizations at runtime is accurately and reliably recognizing the different patterns or phases of the processing workloads encountered by a processor. Efficient and reliable workload phase recognition is crucial to building flexible processor architectures that can adapt on-the-fly in response to real-world circumstances and user needs. The embodiments described in connection with FIGS. 2A-C provide reliable on-chip workload phase recognition, and thus can be used to significantly improve the performance and power efficiency of a processing architecture.

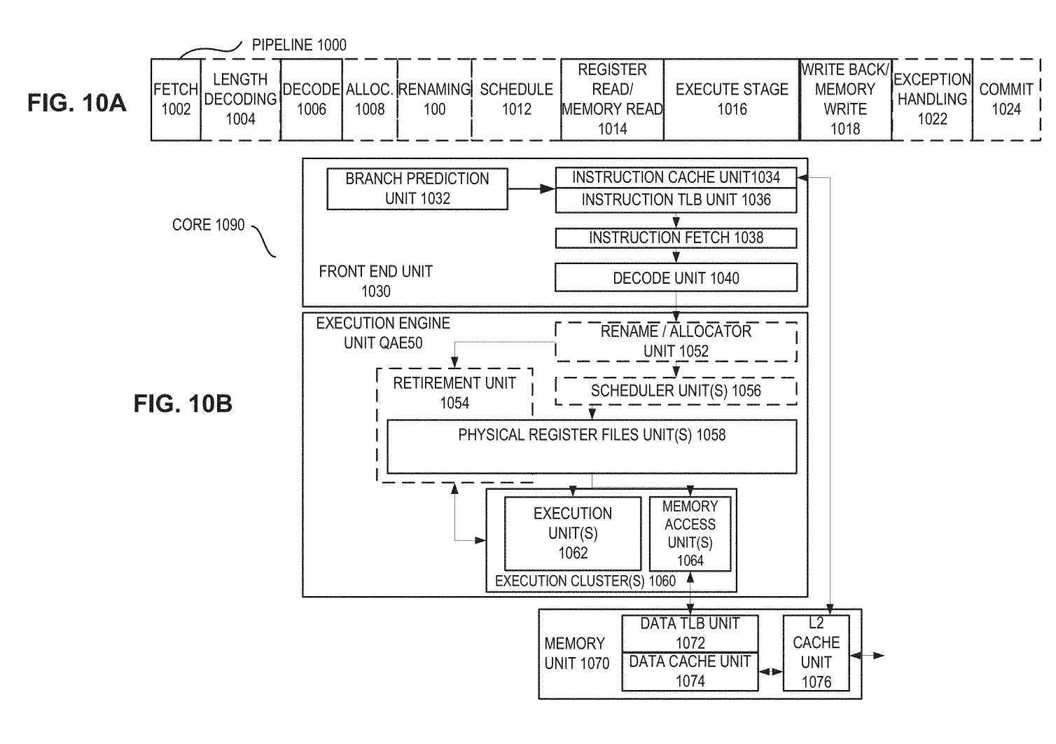

FIG. 2A illustrates an example embodiment of a processor optimization unit 200. Processor optimization unit 200 may be used to dynamically adapt or optimize a processor based on the workloads encountered at runtime. In some embodiments, for example, processor optimization unit 200 may be implemented “on-chip” in a processor architecture, such as the processor architectures of FIGS. 10-15. Processor optimization unit 200 may be implemented, for example, using circuitry and/or logic associated with a processor. For example, processor optimization unit 200 may be implemented in one or more silicon cores of a microcontroller, microprocessor, application specific integrated circuit (ASIC), field programmable gate array (FPGA), and/or other semiconductor chip.

Processor optimization unit 200 analyzes processor workloads in real-time to recognize and learn workload phases and adapt to real-world data variations at runtime. In some embodiments, for example, on-chip machine learning may be used to learn and recognize the signatures associated with different workload phases, enabling consistent and stable phase recognition even in unanticipated runtime conditions. Processor optimization unit 200 provides reliable phase recognition using various machine learning and statistical techniques, such as soft-thresholding, convolution, and/or chi-squared error models, as discussed further below. These statistical techniques are applied to streams of real-time performance event counters, enabling stable phase recognition across both fine-grained time scales of tens-of-thousands of instructions, and coarse-grained time scales of tens-of-millions of instructions. In this manner, a processor can be optimized or adapted based on the specific workload phases that are encountered, for example, by adjusting processor voltage to improve power efficiency, adjusting the width of the execution pipeline during periods with systematically poor speculation, tailoring branch prediction, cache pre-fetch, and/or scheduling units based on identified program characteristics and patterns, and so forth.

In order to adapt a processor to recurring patterns of a program state at a fine-grained scale, learning and recognition of workload phases must be reliably performed on-chip in a manner that is stable to unexpected runtime conditions. The embodiments described throughout this disclosure address various obstacles facing reliable on-chip workload phase recognition at runtime. First, small noisy variations in workload patterns (e.g., variations in architecture-level event counters) are amplified at short time-scales relative to the program-driven patterns that must be recognized. Next, small changes in the timing of pattern recurrence can cause unstable local recognition (e.g. oscillations) when applied to streaming processor event counter data. Finally, programs may produce data at runtime that was neither anticipated at design time nor captured during offline analysis, leading to unexpected phase recognition results and potentially poor adaptation decisions. To address these obstacles, various machine learning and statistical techniques can be implemented on-chip to model the event counter data, such as soft-thresholding to filter noise, convolution to provide invariance to small temporal shifts, and a chi-squared probability model to address out-of-set data detection.

The illustrated embodiment provides various tradeoffs in order to achieve reliable workload phase recognition even for noisy streaming workload data. For example, with respect to the universe of possible workload phases, the workload phases for which architectural optimizations are being targeted must be accurately recognized on-chip, while also guaranteeing accurate negative recognition of all other workload phases. Moreover, immediate and stable phase recognition must be achieved even without the flexibility to roll and analyze results into summary statistics over large volumes of data. Accordingly, the illustrated embodiment is designed to tolerate widely varying workload data without requiring prior training on a comprehensive dataset, coarse summary statistics, or offline computations.

For example, soft-thresholding can be used to implement a local rule for reducing small noise variations to a tolerable level, without needing to individually tailor or adjust the noise filtering threshold for different workloads. Moreover, convolutional pattern matching facilitates shift invariance in order to stabilize phase recognition within local windows of event counter data. Finally, chi-squared testing can then be used to recognize unexpected workload phases or program states based on a probability model of both the bias and magnitude of errors between new and previously recognized workload signatures.

In this manner, real-time learning and recognition of workload phases can be performed reliably without any tailored or manual parameter adjustments (e.g., per-workload parameter tuning, post-processing, or smoothing), which is a mandatory constraint for on-chip optimizations. This is accomplished by analyzing the distribution of differences in event counters between real-time workload data and known (e.g., previously recognized) workload signatures. This approach aligns closely with real-world workload patterns, as the differences in event counter values from one workload snapshot to the next often have a normal or Gaussian distribution, even though the actual workload event counts do not. Accordingly, this approach is more robust than other workload recognition approaches, such as those that simply employ a threshold associated with the magnitude of the differences in event counts.

In the illustrated embodiment, processor optimization unit 200 includes functionality for event monitoring 210, phase recognition 220, and runtime optimization 230. Event monitoring 210 is used to track, aggregate, and filter various performance-related event counters for each processing workload. Phase recognition 220 is then used to recognize or learn the phase of a particular workload based on the processed event counter data obtained during the event monitoring 210 stage. Runtime optimization 230 is then used to perform the appropriate processor optimizations based on the particular workload phase that is recognized using phase recognition 220.

FIG. 2B illustrates an example embodiment of the event monitoring functionality 210 performed by processor optimization unit 200 of FIG. 2A. During the event monitoring stage, various performance-related event counters associated with each processing workload are tracked, aggregated, and filtered, as described further below. The resulting event counter data can then be used to perform phase recognition 220 for a particular workload, as described further in connection with FIG. 2C.

First, various performance-related event counters 214 are tracked for each processing workload snapshot. The event counters 214 can include any operational or performance aspects tracked by a processor, such as the number of branch prediction hits and misses, the number of cache hits and misses, the number of loads from memory, the amount of data transmitted internally within a processor, the number of instructions issued to different parts of the instruction pipeline, among other examples. Moreover, these event counters 214 are tracked and processed separately for each processing workload snapshot. For example, a workload may be a configurable number of processor instructions (represented as t_{recognition} processing instructions), such as 10,000 processor instructions. Accordingly, event counters 214 are tracked for each workload snapshot based on the defined workload size.

The event counters 214 associated with the current processing workload snapshot are first aggregated into an event vector 215. The event counter data in event vector 215 is then processed and/or filtered to reduce noise. In some embodiments, for example, “soft-thresholding” may be used to reduce the noise to a tolerable level. For example, using soft-thresholding, any event counters in event vector 215 whose values are below a particular threshold (θₙₒᵢₛₑ) may be truncated to 0. The particular threshold (θₙₒᵢₛₑ) used for soft-thresholding may be varied to control the degree of noise reduction applied to the event counter data.

After noise reduction is performed, the event vector 215 for the current workload may then be stored in an event buffer 216. In some embodiments, for example, an event buffer 216 may be used to store the event vectors for a configurable number of recent workload snapshots (defined by the workload window size, w_{recognition}). For example, if the workload window size is defined to be three workload snapshots (w_{recognition}=3), the event buffer 216 will maintain event vectors 218a-c for the three most recent workload snapshots (e.g., the current workload and the two preceding workloads). Phase recognition can then be performed using the event vectors 218 associated with the current processing window, as described further in connection with phase recognition functionality 220 of FIG. 2C.

In some embodiments, the various parameters used for monitoring and processing events may be configurable, including the number and type of event counters (t_{counter}), the noise reduction threshold (θₙₒᵢₛₑ), the size of a workload snapshot (t_{recognition}), and the size of the current workload window (w_{recognition}).

For example, the number and type of event counters tracked for phase recognition purposes (represented as t_{counter} total counters) may be adjusted to control the accuracy and/or speed of the phase recognition. Tracking a larger number of event counters may result in more accurate phase recognition, but may require more processing time. In some embodiments, for example, phase recognition may be performed using 600 or more event counters (e.g., t_{counter}=600), while other embodiments may track a reduced set of event counters while still achieving good phase recognition performance, such as 60 event counters (e.g., t_{counter}=60) or even as few as 20 event counters (e.g., t_{counter}=20).

As another example, the noise reduction threshold (θₙₒᵢₛₑ) used for soft-thresholding may be varied to control the degree of noise reduction applied to the event counter data for a particular workload. Larger threshold values may filter more noise and thus may result in more accurate phase recognition, whereas smaller threshold values may admit more noise and thus may result in diminished phase recognition performance. In some embodiments, performing soft-soft-thresholding using a threshold value of at least 32 (θₙₒᵢₛₑ=32) may be sufficient to filter event counter values that are statistically unstable. For example, if soft-thresholding is performed using a noise threshold of 32 (θₙₒᵢₛₑ=32), any event counters in event vector 215 with values below 32 would be truncated to 0.

Finally, the size of a workload (t_{recognition}) can be adjusted to control the minimum detectable phase size. Moreover, the size of the current workload window (w_{recognition}) can be adjusted to control the sensitivity for recognizing changes in phase. For example, a larger workload window may result in slower but more accurate reactions to phase changes, while a smaller workload window may result in faster but less accurate reactions to phase changes.

FIG. 2C illustrates an example embodiment of the phase recognition functionality 220 performed by processor optimization unit 200 of FIG. 2A.

In the illustrated embodiment, phase recognition is performed using a nearest neighbor lookup technique based on convolutional chi-squared testing. Since phases may contain natural patterns that last longer than the size of a workload snapshot (t_{recognition}) (e.g., longer than 10,000 instructions), a known phase is represented by a phase signature comprised of back-to-back event vectors or histograms. Each phase signature is comprised of a configurable number of histograms (w_{signature}), such as 3 histograms per signature. The number of histograms (w_{signature}) in each phase signature can be chosen to encompass the maximum expected duration of recurring patterns within any given phase. Representing phase signatures using a large number of histograms may result in coarse phase definitions that encompass multiple microarchitecture states, while using a small number of histograms may produce fine-grained phase definitions that repeat back-to-back. In some embodiments or configurations, the number of histograms in a phase signature may mirror the size of the workload processing window (e.g., w_{signature}=w_{recognition}).

Phase recognition can be performed by comparing the current workload window 217 to a library of known phases 221. For example, in the illustrated embodiment, convolutional chi-squared comparisons are used to compare the current workload window 217 to each known phase 221. For example, in order to compare the current workload window 217 to a particular known phase 221, each event vector 218 in the current workload window 217 is compared with each histogram 223 in the particular signature 222. This results in a number of comparisons equal to the workload window size multiplied by the number of histograms in the phase signature (e.g., # of comparisons=w_{recognition}*w_{signature}). Moreover, each comparison can be performed by computing the chi-squared distance between a particular event vector 218 and a particular phase signature histogram 223. These calculations are performed for each event vector 218 and each histogram 223 of each known phase 221. The results of these chi-squared calculations are then filtered to identify the known phase with the closest matching score. This process provides shift invariance by choosing the strongest match within the w_{recognition} window of most recent workload snapshots, against any of the w_{signature} phase signature histograms, regardless of order.

Using chi-squared calculations to perform these phase comparisons is based on a straightforward assumption about events during a phase: although the actual event counts may fluctuate, the differences in event counts from one workload snapshot to the next should be normally distributed. Extreme fluctuations are evidence that the workload has entered a different phase. Accordingly, a chi-squared test statistic is computed as the squared sum of differences between the current phase signature histogram u and recently measured data v, scaled by the variance of differences for that event, as illustrated by the following formula:

$${X}^{2} = {\sum }_{i = 1}^{k} \frac{{( {μ}_{u - v} - ( u - v ) )}^{2}}{{σ}_{u - v}^{2}}$$

In the above formula, μᵤ₋ᵥ represents the average difference between two workload snapshots of each counter, and σ²ᵤ₋ᵥ represents the variance between subsequent snapshots of each event type. These parameters are computed in advance and are fixed for all workloads. Finally, the probability that two event vectors represent a different phase can be determined by comparing the computed test statistic to the chi-squared distribution using a probability lookup table. For example, the lookup can be performed using a chi-squared cumulative distribution function (CDF), as illustrated below, where X² represents the computed test statistic and k represents the number of non-zero counter values that remain after soft-thresholding is performed:

p=chi-squared_CDF(X²,k−1)

The computed probability p represents the likelihood that two event vectors represent a different phase. Accordingly, a phase match is identified when p is below a certain threshold (e.g., below 0.5). However, if the current processing window does not match any known phase signatures within that threshold, then it is determined that a new phase has been identified, and thus a new phase label is assigned.

In the illustrated embodiment, each chi-squared comparison 224 is performed using an arithmetic unit 225, accumulator 226, and probability lookup table 227. For example, the chi-squared test statistic identified above (X²) is calculated using arithmetic unit 225 and accumulator 226. Arithmetic unit 225 performs arithmetic on each pair of event counters in the current phase histogram (u) and the recent event vector data (v), while accumulator 226 sums the results. The resulting chi-squared test statistic is then converted into a corresponding probability using probability lookup table 227. A probability is determined in this manner for each histogram 223 in the signature 222 of a known phase 221. The probability that indicates the best match 228 is then output as the probability associated with the particular known phase 221. Once a probability has been determined in this manner for each known phase, the probabilities of the known phases are then compared to identify the known phase with the best match 229.

Finally, phase recognition must be performed efficiently in order to avoid any delay or latency in determining when a transition to a new phase has occurred. Assuming a workload snapshot size of t_{recognition}=10,000 instructions and a maximum number of instructions-per-clock (IPC) of 7.0 instructions, phase recognition must be performed in approximately 1500 clock cycles. There are two primary sources of latency associated with the described embodiment of phase recognition: event monitoring and phase matching. With respect to event monitoring, since no preprocessing of event counter vectors is required other than soft-thresholding, the latency is simply the time required to route t_{counter} event counter values to the phase recognition 220 unit, resulting in a fixed delay. With respect to phase matching, the phase recognition approach described above requires w_{recognition}*w_{signature} chi-squared matching operations, where each matching operation is composed of parallel arithmetic operations on t_{counter} event counters followed by a probability table lookup. To provide an example of the phase recognition latency, assuming 16 known phases have been recognized, the workload window size and the phase signature histogram size are each set to 5 (w_{recognition}=w_{signature}=5), the number of event counters is 20 (t_{counter}=20), and the match computation time is 10 cycles, recognizing a phase requires a baseline of 800 cycles (e.g., 10 cycles*16 known phases*5 phase signature histograms). Moreover, because the phase matching operations are data parallel, the convolutional matching performed against each histogram of a known phase can be performed in parallel (as shown in FIG. 2C), reducing the phase recognition latency to 160 cycles (e.g., 10 cycles*16 known phases*1 phase signature histogram). Finally, the entire phase recognition process only needs to be performed when a deviation from the current phase signature is detected. For example, if the event vector for the current workload snapshot matches the signature of the current known phase, then no phase transition has occurred, and thus phase matching does not need to be performed against the other known phases. Accordingly, for the vast majority of workload snapshots (e.g., over 95% in some cases), phase matching only needs to be performed between the event vector for the current workload snapshot and the signature of the current phase, which requires 50 clock cycles assuming no parallel processing is performed (e.g., 10 cycles*1 known phase*5 phase signature histograms). Accordingly, based on these assumptions, the average computation time for performing phase recognition is approximately 80 clock cycles, with a worst case of 800 clock cycles.

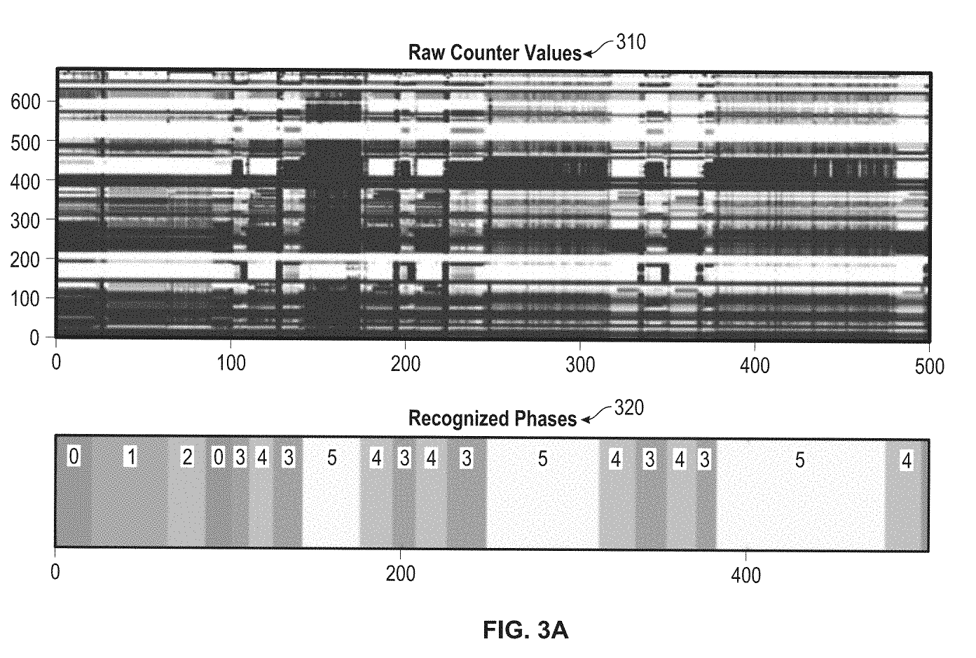

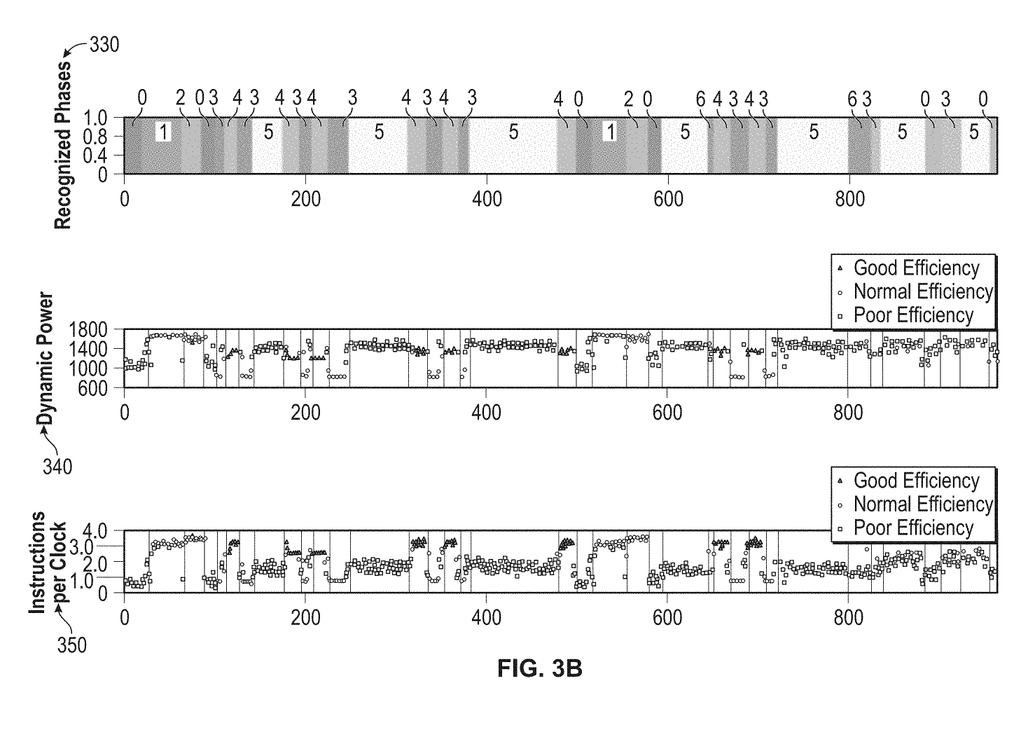

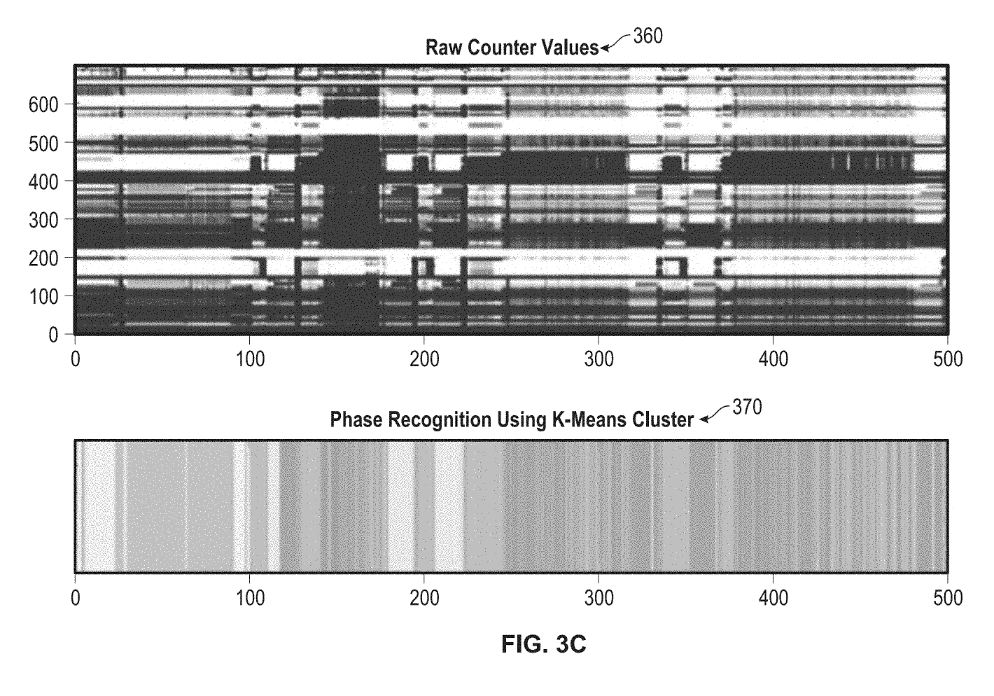

FIGS. 3A-C illustrate performance metrics for example embodiments of processor workload phase learning.

FIGS. 3A and 3B illustrate the performance of the phase detection techniques described in connection with FIGS. 2A-C. In particular, FIG. 3A illustrates raw counter values 310 and the corresponding phases recognition results 320 using the phase recognition embodiments described throughout this disclosure. With respect to the raw counter values 310, the y-axis represents the counter index of each tracked counter and the x-axis represents time. The recognized phases 320 depict the various workload phases recognized during the illustrated time window based on the raw counter values 310. FIG. 3B illustrates a comparison between the phase recognition results 330 and out-of-band performance data during a particular time window. The out-of-band performance data includes dynamic power measurements 340 and instructions-per-clock 350. As shown by the illustrated metrics, the recognized phases 330 align closely with patterns reflected by performance data 340 and 350. In particular, both the duration and repetition of the recognized phases 330 align closely with the patterns in the performance data 340 and 350.

FIG. 3C illustrates the performance of a phase detection technique based on k-means clustering. In particular, FIG. 3C compares raw event counter values 360 to the corresponding phases 370 recognized using k-means clustering. In the illustrated embodiment, clusters associated with the event counter data are learned offline using a training set, and then phase recognition is performed online by matching new event measurements to their closest cluster centroid. This approach uses a pre-trained model to reduce noise, provides no explicit shift invariance, and does not explicitly identify out-of-set data. As shown by the illustrated data, although a few clusters tend to dominate for a period of time in a workload, the results are noisy and would require additional summarization to provide stable phase labels. A comparison of FIG. 3C to FIG. 3A demonstrates the gain in stability provided when using the phase recognition technique employed in FIG. 3A.

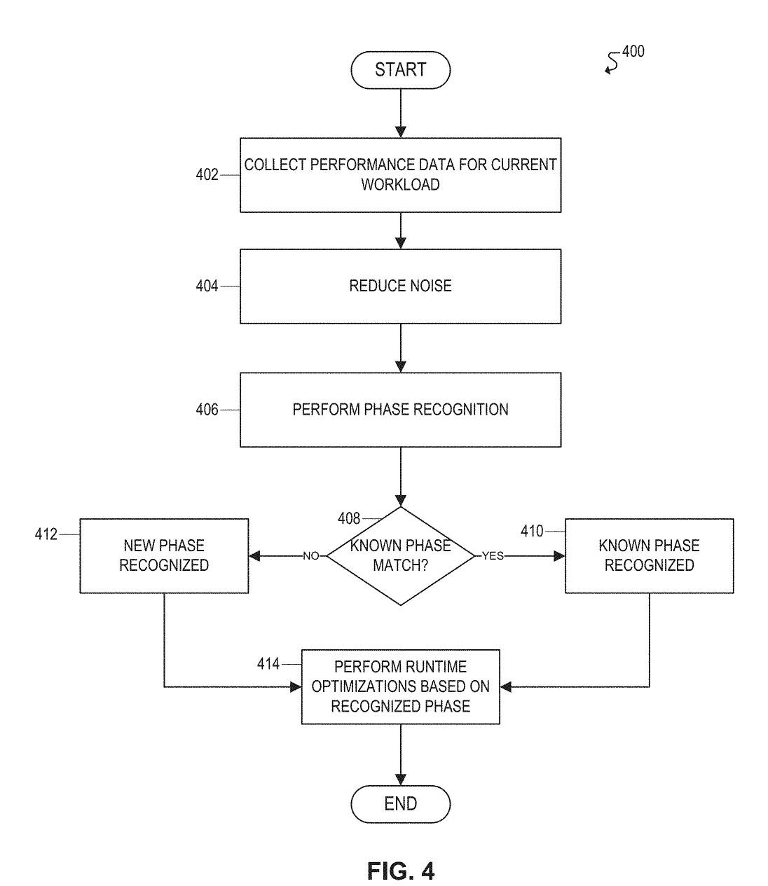

FIG. 4 illustrates a flowchart 400 for an example embodiment of on-chip processor optimization. Flowchart 400 may be implemented, for example, using the embodiments and components described throughout this disclosure.

The flowchart may begin at block 402 by collecting performance data for the current processing workload. For example, in some embodiments, various performance-related event counters may be tracked for the current processing workload. The event counters can include any operational or performance aspects tracked by a processor, including the number of branch prediction hits and misses, the number of cache hits and misses, the number of loads from memory, the amount of data transmitted internally within a processor, and the number of instructions issued to different parts of the instruction pipeline, among other examples. Moreover, in some embodiments, these event counters may be tracked and processed separately for workload snapshots of a defined size (e.g., 10,000 instructions).

The flowchart may then proceed to block 404 to filter the performance data to reduce noise. In some embodiments, for example, “soft-thresholding” may be used to reduce the noise to a tolerable level. For example, using soft-thresholding, any event counters whose values are below a particular threshold (θₙₒᵢₛₑ) may be truncated to 0. The particular threshold (θₙₒᵢₛₑ) used for soft-thresholding may be varied to control the degree of noise reduction applied to the event counter data.

The flowchart may then proceed to block 406 to perform phase recognition, for example, by comparing the performance data for the current workload snapshot to a library of known phases. In some embodiments, phase recognition is performed using a nearest neighbor lookup technique based on convolutional chi-squared testing. For example, in order to compare the current workload snapshot to a particular known phase, the event data for the current workload window is compared to a signature for the known phase. The comparisons can be performed by computing the chi-squared distance between event data and a phase signature. The results of these chi-squared calculations are then filtered to identify the known phase with the closest matching score. This process provides shift invariance by choosing the strongest match within a window of recent workload snapshots, against any of the phase signatures, regardless of order.

The flowchart may then proceed to block 408 to determine whether the current workload snapshot matches a known phase. For example, in some embodiments, a match is detected if the closest chi-squared score is beyond a particular threshold. If a match is detected, the flowchart proceeds to block 410, where a known phase is recognized. Otherwise, if the current workload snapshot does not match any of the known phases, the flowchart proceeds to block 412, where a new phase is recognized and added to the library of known phases.

The flowchart may then proceed to block 414 to perform runtime optimizations based on the recognized phase. For example, a processor can be optimized or adapted based on the specific workload phases that are encountered, for example, by adjusting processor voltage to improve power efficiency, adjusting the width of the execution pipeline during periods with systematically poor speculation, tailoring branch prediction, cache pre-fetch, and/or scheduling units based on identified program characteristics and patterns, and so forth.

At this point, the flowchart may be complete. In some embodiments, however, the flowchart may restart and/or certain blocks may be repeated. For example, in some embodiments, the flowchart may restart at block 402 to continue collecting runtime information to optimize the performance of computing devices.

Cloud-Based Processor Optimization

FIG. 5 illustrates a block diagram for an example embodiment of cloud-based processor optimization 500. The ability to tailor the performance of a processor to diverse workloads is fundamentally limited by the accuracy of the predictive program behavior models leveraged by the processor. These predictive models are themselves subject to computation, timing, and storage constraints. For example, while a branch predictor can be used to model and predict program execution path, it may only be capable of performing simple pattern recognition on small-scale data due to the constraints of front-end, at-speed processor operation. As a result, resource limitations may prevent a branch predictor from recognizing predictive behaviors over large time scales, such as hundreds of millions of instructions. Similar limitations affect data pre-fetch, scheduling, cache eviction, and power usage policies. These examples all represent micro-architectural components whose performance would improve were they adaptable to program behavior. Accordingly, performing certain program behavior modeling “off-chip” (e.g., in the cloud) rather than “on-chip” (e.g., on the processor) may increase the computation and data budgets available for modeling, thus making sophisticated machine learning and runtime optimizations feasible.

An example embodiment of cloud-based processor optimization 500 is illustrated in FIG. 5. In the illustrated embodiment, a cloud service 520 performs certain runtime modeling and machine learning techniques to derive runtime optimizations for a processor 514 of a user device 510. A user device 510, for example, may be any device or machine with a processor 514, including servers and end-user computing devices, among other examples. Moreover, in some embodiments, cloud service 520 and user devices 510 may include a communication interface to communicate with each other over a network.

First, runtime data 502 (e.g., program and/or hardware states) is collected from processors 514 or other chips of user devices 510, and the runtime data 502 is uploaded to a cloud service 520. For example, in some embodiments, an optimization unit 516 of a processor 514 may collect runtime data 502 from certain components 518 of the processor, and the runtime data 502 may then provided to the cloud service 520. The cloud service 520 then uses the runtime data 502 to perform machine learning at a data-center-scale to recognize workload patterns and derive optimization related metadata 504 for the user devices 510. For example, in some embodiments, the cloud service 520 may derive optimization related metadata 504 using branch modeling 521, data access modeling 522, and/or phase identification 523. The cloud service 520 then distributes the optimization metadata 504 to the user devices 510, which the user devices 510 then use to perform appropriate runtime processor optimizations.

For example, in some embodiments, cloud service 520 may use machine learning to derive runtime hardware optimizations by: (1) collecting trace data from user devices 510 at runtime; (2) analyzing program structure using large-scale data-driven modeling and learning techniques; and (3) returning metadata 504 to the user devices 510 that can be used to adjust reconfigurable processor components 514 or other hardware. In this manner, processors and other hardware can be tailored to user applications 511 at runtime, providing improved flexibility and performance over approaches that only allow similar tuning to be performed during the development stage (e.g., profile-guided optimization techniques).

In general, performing “off-chip” modeling and machine learning is ideal for use cases where the delay and data transmission costs of transmitting data off-chip can be amortized by strong long-term performance on a small set of workloads. Example use cases include servers that repetitively execute high-performance workloads and/or devices that accelerate specific binaries as a performance differentiator.

The illustrated cloud-based learning service is designed to drive adjustments and optimizations on an ongoing basis and can be used with any reconfigurable processor component 518, including branch prediction units (BPU), cache pre-fetchers, and schedulers, among other examples. In this manner, processors and other hardware can be tailored to user applications 511 at runtime without requiring changes or access to source code, providing improved flexibility and performance over approaches that only allow similar tuning to be performed during the development stage, such as profile-guided optimization techniques. Moreover, the class of performance optimizations that can be derived by applying machine learning to runtime data is far more extensive than that of profile-guided optimization, which requires representative datasets at design time and realistic recompilation time. In particular, cloud-based computing enables processor optimizations to be derived using sophisticated machine learning techniques (e.g., convolutional neural networks and data dependency tracking) that cannot be implemented “on-chip” by a processor due to performance constraints. Leveraging cloud-based computing to adapt a processor to its workload at runtime can reduce application development time and cost, particularly when building highly-optimized applications. Moreover, cloud-based computing enables processors to be adapted to novel workloads in a manner that is orders-of-magnitude more powerful than on-chip adaptation mechanisms. For example, the limited-scope pattern matching used in on-chip branch predictors is unable to recognize and leverage long-term data-dependency relationships. Similarly, basic stride detection policies used in data pre-fetchers are unable to capture data access patterns over tens-of-thousands of instructions. By contrast, leveraging cloud-based tracing enables identification of long-term predictive relationships between data-dependent branches that are beyond the reach of on-chip learning mechanisms. These relationships can be translated into predictive rules used for performing runtime optimizations and improving processor performance. Finally, the performance of legacy code is still maintained even on new platforms and processors that support cloud-based processor optimization.

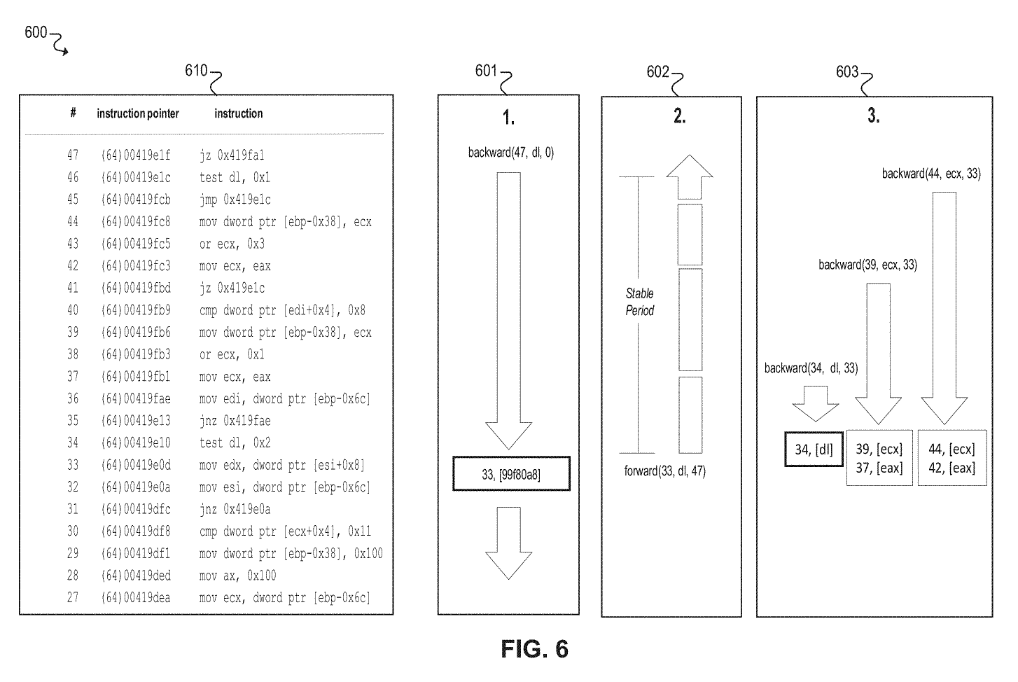

FIG. 6 illustrates an example use case 600 of cloud-based processor optimization. Use case 600 may be performed, for example, using the cloud-based processor optimization architecture 500 of FIG. 5.

Use case 600 illustrates an example of using cloud-based computing to improve branch prediction for a processor, for example, by improving speculation for hard-to-predict branches. As explained further below, various runtime information associated with the processor (e.g., instruction, register, and memory data) is mined during execution of an application, and data-dependency tracking is then leveraged to derive custom prediction rules for hard-to-predict branches. For example, if a hard-to-predict branch is identified in the application, a snippet of the application preceding the hard-to-predict branch (e.g., the retired instructions and any registers or memory addresses that were accessed) is recorded and analyzed to identify relationships between data-dependent execution branches. The identified relationships can then be used, for example, to build custom prediction rules to improve speculation for a critical application on a customer machine.

The data-dependency analysis used for discovering relationships among branches is implemented using backward and forward search procedures. A backward search can be performed using information associated with a hard-to-predict branch. For example, a backward search can be instantiated using a starting point in a trace (e.g., the hard-to-predict branch), a minimum lookback window for terminating the search, and a storage location or data value of interest to be tracked (e.g., a data value used in the branch condition). The lookback window that precedes the specified starting point is then searched to identify the instruction pointer and position of the most recent instruction that modifies the tracked data value, along with any operands used in the modification. If a corresponding instruction within the lookback window is identified, the procedure recursively calls additional backward searches for each operand used in the modification.

A forward search can be performed using a starting point in a trace, a maximum look-ahead window for terminating the search, and a tracked data value known to be unmodified in the identified trace window. The look-ahead window that follows the specified starting point corresponds to a “stable” period in which the tracked data value is not modified. The stable period is searched to identify peer branches whose conditions check the tracked data value. For example, the forward search procedure first enumerates all conditional branches within the stable period, and then triggers a backward search for each conditional branch using search limits defined by the branch position and the original starting point of the forward search. The forward search then flags any branch whose backward search reveals the tracked data value to be a contributor to the branch condition.

Accordingly, a backward search can be performed for a hard-to-predict branch in a trace, and forward searches can then be performed for all stable periods identified in its execution path. In this manner, peer branches can be identified whose conditions rely on values that also affect the hard-to-predict branch. Statistically, the directions of the peer branches contain predictive information about the hard-to-predict branch, and thus can be used to train a custom predictor, such as decision tree. For example, a neural network can be trained for the hard-to-predict branches to determine if any improvements in prediction accuracy can be achieved. First, in the feature identification step, learned weights in the neural network can be used to determine correlated branches or features. These features can then be used to build feature vectors, which are used to train a classification model (e.g., a decision tree) to predict the branch outcome. In some embodiments, the classification model could be implemented using a decision tree, although other approaches can also be used.

Use case 600 illustrates an example snippet of instruction trace data 610 collected during execution of an application, which precedes a hard-to-predict branch in the application. The instruction trace data 610 is analyzed by a cloud service using the data dependency analysis described above in order to optimize branch prediction performance. In some cases, a user device executing a particular application may provide the instruction trace data 610 to the cloud service, or alternatively, the cloud service may execute the user application directly to obtain the instruction trace data 610.

In the illustrated example, a hard-to-predict branch is identified at instruction 47 (e.g., a jump zero instruction). Accordingly, in step one 601, a backward search is instantiated using the storage location of the branch condition (e.g., register dl) as the tracked data value, and a minimum lookback window that extends to the beginning of the trace. The backward search is used to identify the most recent modification to register dl and identify any prior dependencies. In the illustrated example, the backward search identifies instruction 33 and determines that memory location 99f80a8 is a prior dependency. At step two 602, a forward search is performed to enumerate branches found in the stable period between instructions 33 and 47, and branches are found at instructions 34, 39, and 44. At step three 603, local backward searches are performed to determine the dependencies of each branch in the stable period identified by the forward search (e.g., the branches at instructions 34, 39, and 44), and the results are checked for overlap with register dl. In this case, the original hard-to-predict branch at instruction 47 and the branch at instruction 34 are found to have interdependent conditions. Accordingly, the direction of the peer branch at instruction 34 can be used as predictive information for the hard-to-predict branch, and can be used to train a custom predictor to improve the branch prediction performance for the hard-to-predict branch.

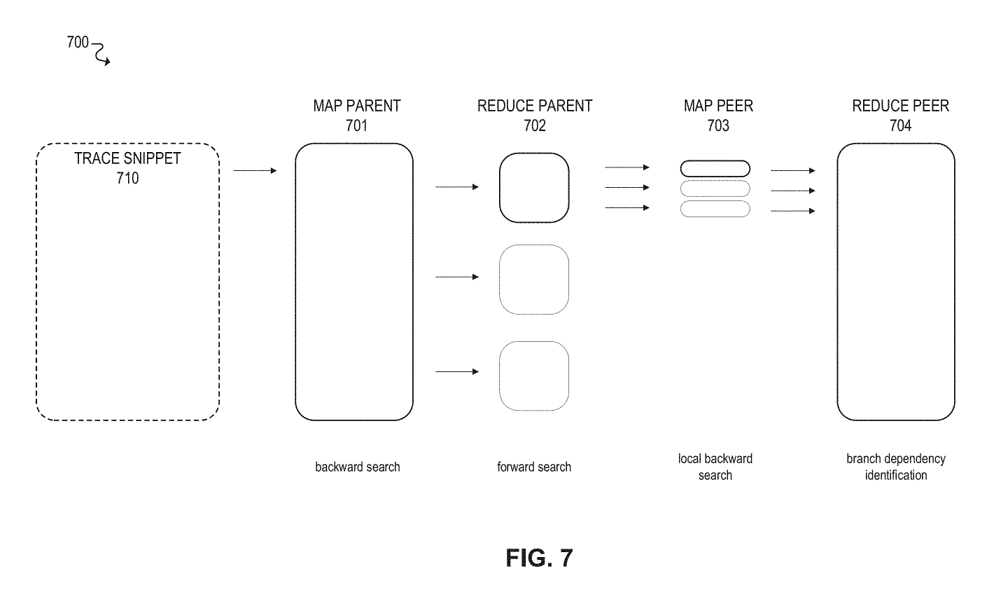

FIG. 7 illustrates an example embodiment of cloud-based processor optimization using a map-reduce implementation 700. The illustrated map-reduce implementation 700, for example, can be used to perform the branch prediction optimization described in connection with FIG. 6.

In general, a map-reduce framework can be used to perform a given task using distributed and/or parallel processing, for example, by distributing the task across various servers in a cloud-based data center. A map-reduce framework provides well-supported infrastructure for large-scale parallel computations, including data distribution, fault tolerance, and straggler detection, among other examples. The illustrated map-reduce implementation 700 demonstrates the increase in analytical power that results from moving program analysis for hardware optimization to the cloud.

In the illustrated example 700, the branch prediction analysis from FIG. 6 is decomposed into parallelizable procedures that can be deployed for computation in a data center using a map-reduce framework. In particular, the illustrated example 700 demonstrates the backward and forward search procedures used for branch prediction can be scaled to a datacenter platform using a map-reduce framework. For example, the branch prediction analysis from FIG. 6 can be implemented using two sets of map and reduce calls, as described below.

First, a “map parent” procedure 701 is called to initiate a backward search for each hard-to-predict branch. The map parent procedure 701 emits a key-value pair identifying the hard-to-predict branch and the stable period, where the stable period is a triple containing the starting position, tracked data location, and ending position for a forward search.

Next, a “reduce parent” procedure 702 is called for each stable period emitted from a backward search performed by the map parent procedure 701. The reduce parent procedure 702 initiates a forward search, which emits the peer branches and the lower boundary of the stable period, which can subsequently be used to conduct local backward searches.

The “map peer” procedure 703 is called for each enumerated branch found in a stable period for a hard-to-predict branch (e.g., the branches emitted by the reduce parent procedure 702). The map peer procedure 703 performs a local backward search and determines whether the tracked data location from the reduce parent procedure 702 is in the list of dependent data locations. Whenever an interdependent peer branch is identified, the map peer procedure 703 emits a key-value pair identifying the hard-to-predict branch and the position of the peer branch instruction.

The “reduce peer” procedure 704 aggregates all interdependent peer branches associated with a hard-to-predict branch and then reports the aggregated branches for further analysis and branch prediction optimization.

Finally, the results of this analysis can be used to build or train a custom predictor for the targeted hard-to-predict branch. Various prediction approaches can be used depending on the reconfiguration options available for a particular processor, including a decision tree trained to associate the directions of the flagged peer branches with the direction of the hard-to-predict branch, or a custom indexing function used by a lookup-based predictor (e.g., a tagged geometric length (TAGE) based predictor).

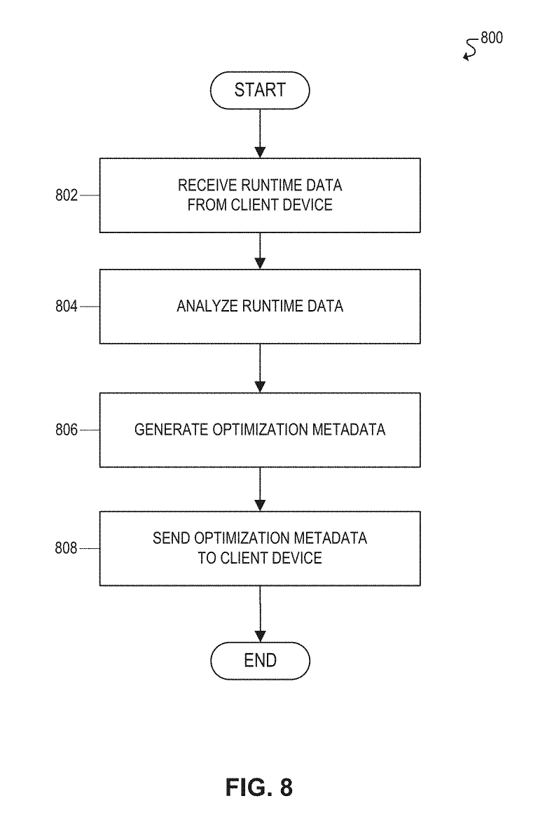

FIG. 8 illustrates a flowchart 800 for an example embodiment of cloud-based processor optimization. Flowchart 800 may be implemented, for example, using the embodiments and components described throughout this disclosure.

The flowchart may begin at block 802 by receiving runtime data from a client device. In some embodiments, runtime data (e.g., program and/or hardware states) is collected by a client computing device, and the runtime data is then sent from the client device to a cloud service. For example, an optimization unit of a client processor may collect runtime data from certain components of the processor, and the runtime data may then be provided to the cloud service. Alternatively, the cloud service may obtain the runtime data by directly executing a particular client application.

The flowchart may then proceed to block 804 to analyze the runtime data. For example, the cloud service can use the runtime data to perform machine learning at a data-center-scale to recognize workload patterns and derive optimizations for the client device. For example, in some embodiments, the cloud service may analyze the runtime data using branch modeling, data access modeling, and/or phase recognition.

The flowchart may then proceed to block 806 to generate optimization metadata for the client device. The optimization metadata, for example, is derived from the analysis of runtime data, and contains information relating to processor optimizations that can be performed by the client device.

The flowchart may then proceed to block 808 to send the optimization metadata to the client device. For example, the cloud service sends the optimization metadata to the client device, enabling the client device to use the optimization metadata to perform the appropriate runtime optimizations. In this manner, processors and other hardware can be tailored to client applications at runtime, providing improved flexibility and performance over approaches that only allow similar tuning to be performed during the development stage (e.g., profile-guided optimization techniques).

At this point, the flowchart may be complete. In some embodiments, however, the flowchart may restart and/or certain blocks may be repeated. For example, in some embodiments, the flowchart may restart at block 802 to continue collecting runtime information to optimize the performance of computing devices.

Processor Optimization Using On-Chip and Cloud Learning

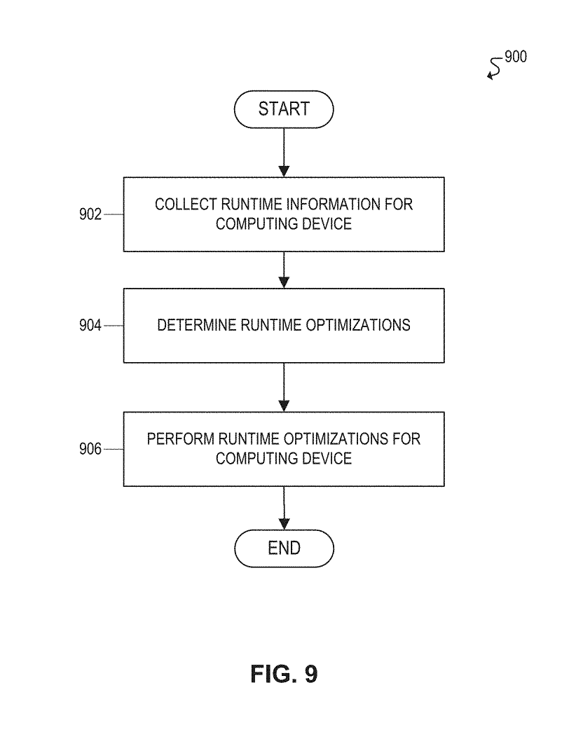

FIG. 9 illustrates a flowchart 900 for an example embodiment of runtime processor optimization. Flowchart 900 may be implemented, for example, using the embodiments and components described throughout this disclosure.

The flowchart may begin at block 902 by collecting runtime information associated with a computing device. The runtime information, for example, could include any performance or operational information associated with the computing device (or an associated processor or application), including performance related data (e.g., performance event counters for a processor), processor or application state information (e.g., instruction, register, and/or memory data from an application trace), and so forth.

In some cases, the runtime information may be collected by the computing device and/or an associated processor. In some cases, the runtime information may also be collected by a cloud optimization service. For example, in some cases, the computing device could transmit runtime information to the cloud optimization service, or alternatively, the cloud optimization service could execute the application associated with the computing device to collect the runtime information directly.

The flowchart may then proceed to block 904 to receive and/or or determine runtime optimization information for the computing device. The runtime optimization information may be determined, for example, using machine learning based on the collected runtime information. In some cases, the runtime optimization information may be determined by the computing device and/or an associated processor. The runtime optimization information may also be determined for the computing device by a cloud optimization service, and then transmitted from the cloud optimization service to the computing device.

In some cases, the runtime optimization information may be determined using phase recognition (e.g., as described in connection with FIGS. 2-4). The runtime optimization information could be derived, for example, by recognizing patterns in phases associated with the workloads processed by the computing device. For example, in some cases, the collected runtime information may include a plurality of event counters associated with a snapshot of the workload of the computing device. Moreover, phase recognition may be performed to recognize a phase associated with the workload snapshot based on the event counter data. In some cases, phase recognition may be performed using soft-thresholding to reduce or filter noise, convolutional comparisons to provide invariance to small temporal shifts, and/or chi-squared probability calculations to address out-of-set data detection.

In some cases, the runtime optimization information may be determined using branch prediction learning to improve the branch prediction performance of the computing device (e.g., as described in connection with FIGS. 5-8). For example, in some cases, the collected runtime information may include instruction trace data associated with an application executed on the computing device, and the instruction trace data may comprise a plurality of branch instructions. Moreover, the plurality of branch instructions may include a hard-to-predict branch. Accordingly, a branch dependency analysis can be performed to identify relationships associated with the branch instructions, and the identified relationships can then be used to derive predictive information for improving branch prediction for the hard-to-predict branch.

The flowchart may then proceed to block 906 to perform one or more runtime optimizations for the computing device based on the runtime optimization information. For example, based on the runtime optimization information received at block 904, various optimizations can be performed to improve the performance of the computing device, such as adjusting processor voltage to improve power efficiency, adjusting the width of the execution pipeline during periods with systematically poor speculation, tailoring branch prediction, cache pre-fetch, and/or scheduling units based on identified program characteristics and patterns, and so forth.

At this point, the flowchart may be complete. In some embodiments, however, the flowchart may restart and/or certain blocks may be repeated. For example, in some embodiments, the flowchart may restart at block 902 to continue collecting runtime information to optimize the performance of computing devices.

Example Computer Architectures

FIGS. 10-15 illustrate block diagrams for example embodiments of computer architectures that may be used in accordance with embodiments disclosed herein. For example, in some embodiments, the computer architectures illustrated in FIGS. 10-15 could be used to implement the runtime processor optimization functionality described throughout this disclosure (e.g., the on-chip processor optimizations described in connection with FIGS. 2-4, and/or the cloud-based processor optimizations described in connection with FIGS. 5-8).

Example Core Architectures

FIG. 10A is a block diagram illustrating both an exemplary in-order pipeline and an exemplary register renaming, out-of-order issue/execution pipeline according to embodiments of the invention. FIG. 10B is a block diagram illustrating both an exemplary embodiment of an in-order architecture core and an exemplary register renaming, out-of-order issue/execution architecture core to be included in a processor according to embodiments of the invention. The solid lined boxes in FIGS. 10A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 1000 includes a fetch stage 1002, a length decode stage 1004, a decode stage 1006, an allocation stage 1008, a renaming stage 1010, a scheduling (also known as a dispatch or issue) stage 1012, a register read/memory read stage 1014, an execute stage 1016, a write back/memory write stage 1018, an exception handling stage 1022, and a commit stage 1024.

FIG. 10B shows processor core 1090 including a front end unit 1030 coupled to an execution engine unit 1050, and both are coupled to a memory unit 1070. The core 1090 may be a reduced instruction set computing (RISC) core, a complex instruction set computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front end unit 1030 includes a branch prediction unit 1032 coupled to an instruction cache unit 1034, which is coupled to an instruction translation lookaside buffer (TLB) 1036, which is coupled to an instruction fetch unit 1038, which is coupled to a decode unit 1040. The decode unit 1040 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1040 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1090 includes a microcode ROM or other medium that stores microcode for certain macroinstructions (e.g., in decode unit 1040 or otherwise within the front end unit 1030). The decode unit 1040 is coupled to a rename/allocator unit 1052 in the execution engine unit 1050.

The execution engine unit 1050 includes the rename/allocator unit 1052 coupled to a retirement unit 1054 and a set of one or more scheduler unit(s) 1056. The scheduler unit(s) 1056 represents any number of different schedulers, including reservations stations, central instruction window, etc. The scheduler unit(s) 1056 is coupled to the physical register file(s) unit(s) 1058. Each of the physical register file(s) units 1058 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1058 comprises a vector registers unit, a write mask registers unit, and a scalar registers unit. These register units may provide architectural vector registers, vector mask registers, and general purpose registers. The physical register file(s) unit(s) 1058 is overlapped by the retirement unit 1054 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1054 and the physical register file(s) unit(s) 1058 are coupled to the execution cluster(s) 1060. The execution cluster(s) 1060 includes a set of one or more execution units 1062 and a set of one or more memory access units 1064. The execution units 1062 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1056, physical register file(s) unit(s) 1058, and execution cluster(s) 1060 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1064). It should also be understood that where separate pipelines are used, one or more of these pipelines may be out-of-order issue/execution and the rest in-order.

The set of memory access units 1064 is coupled to the memory unit 1070, which includes a data TLB unit 1072 coupled to a data cache unit 1074 coupled to a level 2 (L2) cache unit 1076. In one exemplary embodiment, the memory access units 1064 may include a load unit, a store address unit, and a store data unit, each of which is coupled to the data TLB unit 1072 in the memory unit 1070. The instruction cache unit 1034 is further coupled to a level 2 (L2) cache unit 1076 in the memory unit 1070. The L2 cache unit 1076 is coupled to one or more other levels of cache and eventually to a main memory.

By way of example, the exemplary register renaming, out-of-order issue/execution core architecture may implement the pipeline 1000 as follows: 1) the instruction fetch 1038 performs the fetch and length decoding stages 1002 and 1004; 2) the decode unit 1040 performs the decode stage 1006; 3) the rename/allocator unit 1052 performs the allocation stage 1008 and renaming stage 1010; 4) the scheduler unit(s) 1056 performs the schedule stage 1012; 5) the physical register file(s) unit(s) 1058 and the memory unit 1070 perform the register read/memory read stage 1014; the execution cluster 1060 perform the execute stage 1016; 6) the memory unit 1070 and the physical register file(s) unit(s) 1058 perform the write back/memory write stage 1018; 7) various units may be involved in the exception handling stage 1022; and 8) the retirement unit 1054 and the physical register file(s) unit(s) 1058 perform the commit stage 1024.

The core 1090 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1090 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1034/1074 and a shared L2 cache unit 1076, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

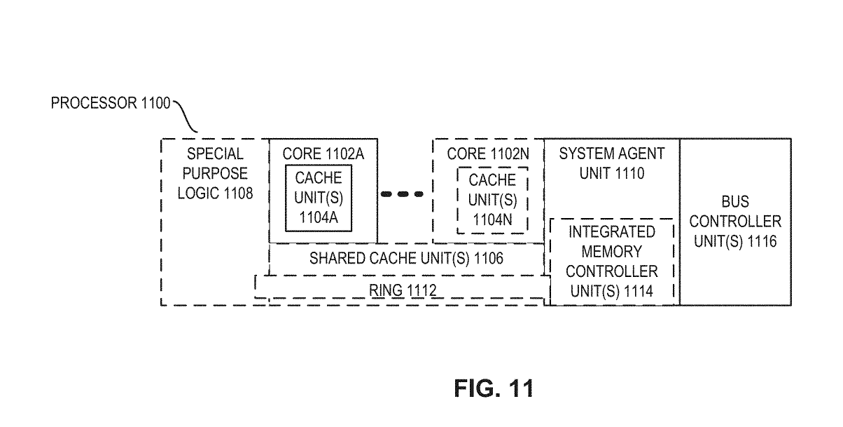

FIG. 11 is a block diagram of a processor 1100 that may have more than one core, may have an integrated memory controller, and may have integrated graphics according to embodiments of the invention. The solid lined boxes in FIG. 11 illustrate a processor 1100 with a single core 1102A, a system agent 1110, a set of one or more bus controller units 1116, while the optional addition of the dashed lined boxes illustrates an alternative processor 1100 with multiple cores 1102A-N, a set of one or more integrated memory controller unit(s) 1114 in the system agent unit 1110, and special purpose logic 1108.

Thus, different implementations of the processor 1100 may include: 1) a CPU with the special purpose logic 1108 being integrated graphics and/or scientific (throughput) logic (which may include one or more cores), and the cores 1102A-N being one or more general purpose cores (e.g., general purpose in-order cores, general purpose out-of-order cores, a combination of the two); 2) a coprocessor with the cores 1102A-N being a large number of special purpose cores intended primarily for graphics and/or scientific (throughput); and 3) a coprocessor with the cores 1102A-N being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1106, and external memory (not shown) coupled to the set of integrated memory controller units 1114. The set of shared cache units 1106 may include one or more mid-level caches, such as level 2 (L2), level 3 (L3), level 4 (L4), or other levels of cache, a last level cache (LLC), and/or combinations thereof. While in one embodiment a ring based interconnect unit 1112 interconnects the integrated graphics logic 1108, the set of shared cache units 1106, and the system agent unit 1110/integrated memory controller unit(s) 1114, alternative embodiments may use any number of well-known techniques for interconnecting such units. In one embodiment, coherency is maintained between one or more cache units 1106 and cores 1102-A-N.

In some embodiments, one or more of the cores 1102A-N are capable of multi-threading. The system agent 1110 includes those components coordinating and operating cores 1102A-N. The system agent unit 1110 may include for example a power control unit (PCU) and a display unit. The PCU may be or include logic and components needed for regulating the power state of the cores 1102A-N and the integrated graphics logic 1108. The display unit is for driving one or more externally connected displays.

The cores 1102A-N may be homogenous or heterogeneous in terms of architecture instruction set; that is, two or more of the cores 1102A-N may be capable of execution the same instruction set, while others may be capable of executing only a subset of that instruction set or a different instruction set.

Example Computer Architectures

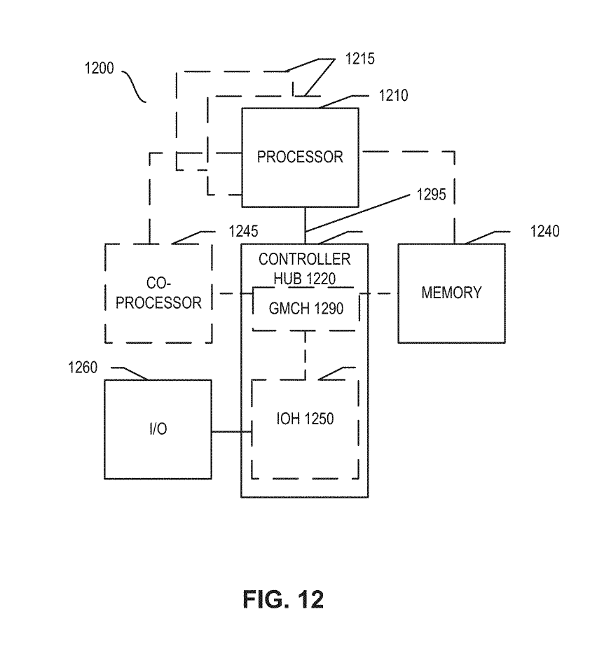

FIGS. 12-14 are block diagrams of example computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 12, shown is a block diagram of a system 1200 in accordance with one embodiment of the present invention. The system 1200 may include one or more processors 1210, 1215, which are coupled to a controller hub 1220. In one embodiment the controller hub 1220 includes a graphics memory controller hub (GMCH) 1290 and an Input/Output Hub (IOH) 1250 (which may be on separate chips); the GMCH 1290 includes memory and graphics controllers to which are coupled memory 1240 and a coprocessor 1245; the IOH 1250 is couples input/output (I/O) devices 1260 to the GMCH 1290. Alternatively, one or both of the memory and graphics controllers are integrated within the processor (as described herein), the memory 1240 and the coprocessor 1245 are coupled directly to the processor 1210, and the controller hub 1220 in a single chip with the IOH 1250.

The optional nature of additional processors 1215 is denoted in FIG. 12 with broken lines. Each processor 1210, 1215 may include one or more of the processing cores described herein and may be some version of the processor 1100.

The memory 1240 may be, for example, dynamic random access memory (DRAM), phase change memory (PCM), or a combination of the two. For at least one embodiment, the controller hub 1220 communicates with the processor(s) 1210, 1215 via a multi-drop bus, such as a frontside bus (FSB), point-to-point interface such as QuickPath Interconnect (QPI), or similar connection 1295.

In one embodiment, the coprocessor 1245 is a special-purpose processor, such as, for example, a high-throughput MIC processor, a network or communication processor, compression engine, graphics processor, GPGPU, embedded processor, or the like. In one embodiment, controller hub 1220 may include an integrated graphics accelerator.

There can be a variety of differences between the physical resources 1210, 1215 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

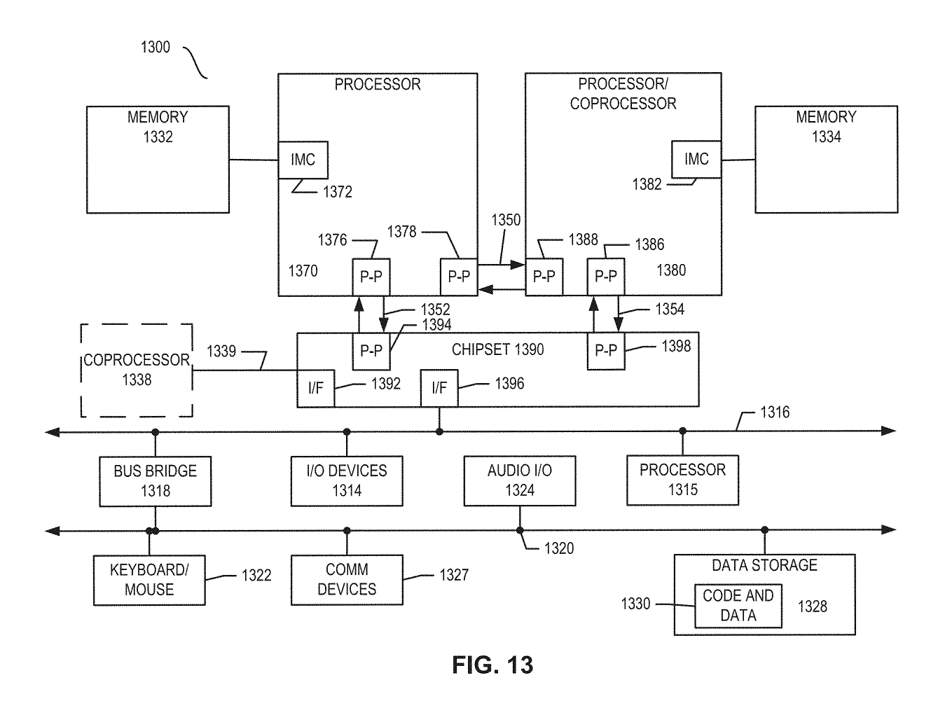

Referring now to FIG. 13, shown is a block diagram of a first more specific exemplary system 1300 in accordance with an embodiment of the present invention. As shown in FIG. 13, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment of the invention, processors 1370 and 1380 are respectively processors 1210 and 1215, while coprocessor 1338 is coprocessor 1245. In another embodiment, processors 1370 and 1380 are respectively processor 1210 coprocessor 1245.

Processors 1370 and 1380 are shown including integrated memory controller (IMC) units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 13, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1339. In one embodiment, the coprocessor 1338 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 13, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU's, accelerators (such as, e.g., graphics accelerators or digital signal processing (DSP) units), field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are possible. For example, instead of the point-to-point architecture of FIG. 13, a system may implement a multi-drop bus or other such architecture.

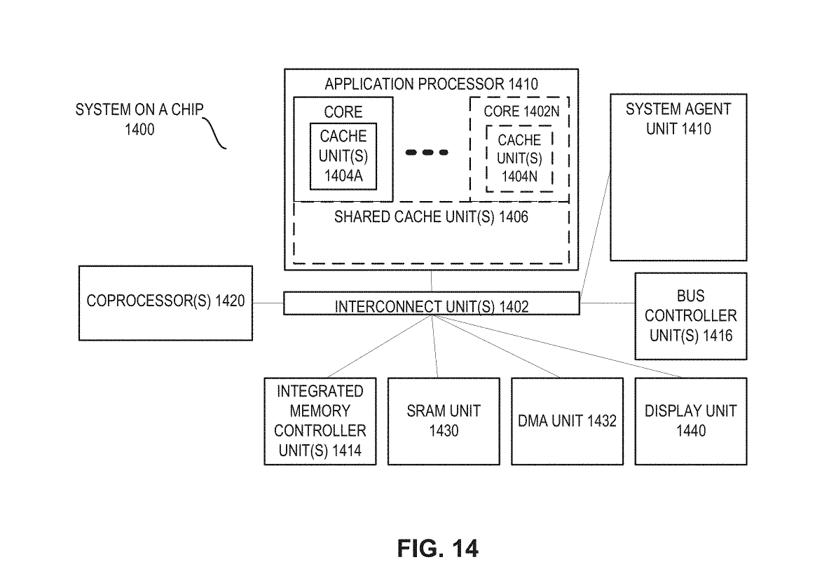

Referring now to FIG. 14, shown is a block diagram of a SoC 1400 in accordance with an embodiment of the present invention. Similar elements in FIG. 11 bear like reference numerals. Also, dashed lined boxes are optional features on more advanced SoCs. In FIG. 14, an interconnect unit(s) 1402 is coupled to: an application processor 1410 which includes a set of one or more cores 202A-N and shared cache unit(s) 1106; a system agent unit 1110; a bus controller unit(s) 1116; an integrated memory controller unit(s) 1114; a set or one or more coprocessors 1420 which may include integrated graphics logic, an image processor, an audio processor, and a video processor; an static random access memory (SRAM) unit 1430; a direct memory access (DMA) unit 1432; and a display unit 1440 for coupling to one or more external displays. In one embodiment, the coprocessor(s) 1420 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 13, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Emulation

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

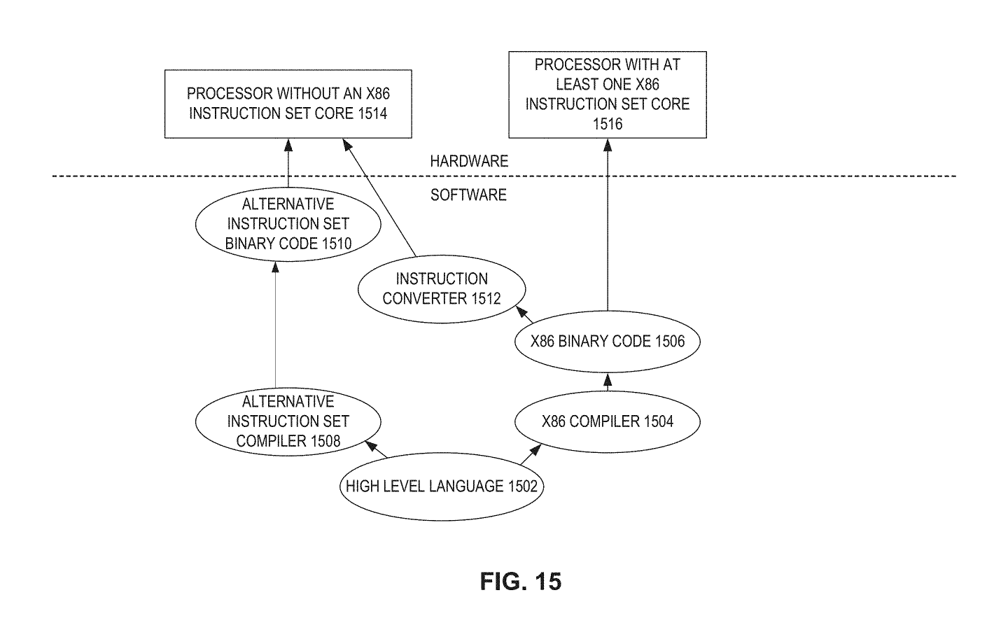

FIG. 15 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 15 shows a program in a high level language 1502 may be compiled using an x86 compiler 1504 to generate x86 binary code 1506 that may be natively executed by a processor with at least one x86 instruction set core 1516. The processor with at least one x86 instruction set core 1516 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1504 represents a compiler that is operable to generate x86 binary code 1506 (e.g., object code) that can, with or without additional linkage processing, be executed on the processor with at least one x86 instruction set core 1516. Similarly, FIG. 15 shows the program in the high level language 1502 may be compiled using an alternative instruction set compiler 1508 to generate alternative instruction set binary code 1510 that may be natively executed by a processor without at least one x86 instruction set core 1514 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1512 is used to convert the x86 binary code 1506 into code that may be natively executed by the processor without an x86 instruction set core 1514. This converted code is not likely to be the same as the alternative instruction set binary code 1510 because an instruction converter capable of this is difficult to make; however, the converted code will accomplish the general operation and be made up of instructions from the alternative instruction set. Thus, the instruction converter 1512 represents software, firmware, hardware, or a combination thereof that, through emulation, simulation or any other process, allows a processor or other electronic device that does not have an x86 instruction set processor or core to execute the x86 binary code 1506.

The flowcharts and block diagrams in the FIGURES illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing disclosure outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including a central processing unit (CPU) package. An SoC represents an integrated circuit (IC) that integrates components of a computer or other electronic system into a single chip. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in Application Specific Integrated Circuits (ASICs), Field Programmable Gate Arrays (FPGAs), and other semiconductor chips.

As used throughout this specification, the term “processor” or “microprocessor” should be understood to include not only a traditional microprocessor (such as Intel's® industry-leading x86 and x64 architectures), but also matrix processors, graphics processors, and any ASIC, FPGA, microcontroller, digital signal processor (DSP), programmable logic device, programmable logic array (PLA), microcode, instruction set, emulated or virtual machine processor, or any similar “Turing-complete” device, combination of devices, or logic elements (hardware or software) that permit the execution of instructions.

Note also that in certain embodiments, some of the components may be omitted or consolidated. In a general sense, the arrangements depicted in the figures should be understood as logical divisions, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute instructions associated with data or microcode to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage may store information in any suitable type of tangible, non-transitory storage medium (for example, random access memory (RAM), read only memory (ROM), field programmable gate array (FPGA), erasable programmable read only memory (EPROM), electrically erasable programmable ROM (EEPROM), or microcode), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein should be construed as being encompassed within the broad terms ‘memory’ and ‘storage,’ as appropriate. A non-transitory storage medium herein is expressly intended to include any non-transitory special-purpose or programmable hardware configured to provide the disclosed operations, or to cause a processor to perform the disclosed operations. A non-transitory storage medium also expressly includes a processor having stored thereon hardware-coded instructions, and optionally microcode instructions or sequences encoded in hardware, firmware, or software.

Computer program logic implementing all or part of the functionality described herein is embodied in various forms, including, but in no way limited to, hardware description language, a source code form, a computer executable form, machine instructions or microcode, programmable hardware, and various intermediate forms (for example, forms generated by an HDL processor, assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

### Example Implementations

The following examples pertain to embodiments described throughout this disclosure.

One or more embodiments may include a processor, comprising: a processor optimization unit to: collect runtime information associated with a computing device, wherein the runtime information comprises information indicating a performance of the computing device during program execution; receive runtime optimization information for the computing device, wherein the runtime optimization information comprises information associated with one or more runtime optimizations for the computing device, and wherein the runtime optimization information is determined based on an analysis of the collected runtime information; and perform the one or more runtime optimizations for the computing device based on the runtime optimization information.

In one example embodiment of a processor, the processor optimization unit to receive the runtime optimization information for the computing device is further to determine the runtime optimization information.

In one example embodiment of a processor, the runtime information comprises a plurality of event counters associated with a workload of the computing device.

In one example embodiment of a processor, the processor optimization unit to determine the runtime optimization information is further to perform phase recognition for the workload of the computing device.

In one example embodiment of a processor, the processor optimization unit to perform phase recognition for the workload of the computing device is further to perform noise reduction using soft-thresholding.

In one example embodiment of a processor, the processor optimization unit to perform phase recognition for the workload of the computing device is further to identify a phase associated with the workload using a convolutional phase comparison.

In one example embodiment of a processor, the processor optimization unit to perform phase recognition for the workload of the computing device is further to identify a phase associated with the workload using a chi-squared calculation.

In one example embodiment of a processor, the processor optimization unit to receive the runtime optimization information for the computing device is further to receive the runtime optimization information from a cloud service remote from the computing device.

In one example embodiment of a processor: the runtime information comprises instruction trace data associated with an application executed on the computing device, wherein the instruction trace data comprises a plurality of branch instructions; and the runtime optimization information is determined by identifying a relationship associated with the plurality of branch instructions to improve branch prediction performed by the computing device.

One or more embodiments may include at least one machine accessible storage medium having instructions stored thereon, the instructions, when executed on a machine, cause the machine to: collect runtime information associated with a computing device, wherein the runtime information comprises information indicating a performance of the computing device during program execution; receive runtime optimization information for the computing device, wherein the runtime optimization information comprises information associated with one or more runtime optimizations for the computing device, and wherein the runtime optimization information is determined based on an analysis of the collected runtime information; and perform the one or more runtime optimizations for the computing device based on the runtime optimization information.

In one example embodiment of a storage medium, the instructions that cause the machine to receive the runtime optimization information for the computing device further cause the machine to determine the runtime optimization information.

In one example embodiment of a storage medium: the runtime information comprises a plurality of event counters associated with a workload of the computing device; and the instructions that cause the machine to determine the runtime optimization information further cause the machine to perform phase recognition for the workload of the computing device.

In one example embodiment of a storage medium, the instructions that cause the machine to perform phase recognition for the workload of the computing device further cause the machine to perform noise reduction using soft-thresholding.

In one example embodiment of a storage medium, the instructions that cause the machine to perform phase recognition for the workload of the computing device further cause the machine to identify a phase associated with the workload using a convolutional phase comparison.

In one example embodiment of a storage medium, the instructions that cause the machine to perform phase recognition for the workload of the computing device further cause the machine to identify a phase associated with the workload using a chi-squared calculation.

In one example embodiment of a storage medium: the runtime information comprises instruction trace data associated with an application executed on the computing device, wherein the instruction trace data comprises a plurality of branch instructions; and the runtime optimization information is determined by identifying a relationship associated with the plurality of branch instructions to improve branch prediction performed by the computing device.

One or more embodiments may include a method, comprising: collecting runtime information associated with a computing device, wherein the runtime information comprises information indicating a performance of the computing device during program execution; receiving runtime optimization information for the computing device, wherein the runtime optimization information comprises information associated with one or more runtime optimizations for the computing device, and wherein the runtime optimization information is determined based on an analysis of the collected runtime information; and performing the one or more runtime optimizations for the computing device based on the runtime optimization information.

In one example embodiment of a method, receiving the runtime optimization information for the computing device further comprises determining the runtime optimization information.

In one example embodiment of a method, the runtime information comprises a plurality of event counters associated with a workload of the computing device; and wherein determining the runtime optimization information comprises performing phase recognition for the workload of the computing device.

In one example embodiment of a method, performing phase recognition for the workload of the computing device comprises performing noise reduction using soft-thresholding.

In one example embodiment of a method, performing phase recognition for the workload of the computing device comprises identifying a phase associated with the workload using a convolutional phase comparison.

In one example embodiment of a method, performing phase recognition for the workload of the computing device comprises identifying a phase associated with the workload using a chi-squared calculation.

In one example embodiment of a method: the runtime information comprises instruction trace data associated with an application executed on the computing device, wherein the instruction trace data comprises a plurality of branch instructions; and the runtime optimization information is determined by identifying a relationship associated with the plurality of branch instructions to improve branch prediction performed by the computing device.

One or more embodiments may include a system, comprising: a communication interface to communicate with a computing device over one or more networks; and a plurality of processors for providing a cloud service for computer optimization, wherein the plurality of processors is to: collect runtime information associated with the computing device, wherein the runtime information comprises information indicating a performance of the computing device during program execution; determine runtime optimization information for the computing device, wherein the runtime optimization information comprises information associated with one or more runtime optimizations for the computing device, and wherein the runtime optimization information is determined based on an analysis of the collected runtime information; and provide the runtime optimization information to the computing device to optimize performance of the computing device.

In one example embodiment of a system: the runtime information comprises instruction trace data associated with an application executed on the computing device, wherein the instruction trace data comprises a plurality of branch instructions; and the plurality of processors to determine the runtime optimization information for the computing device is further to identify a relationship associated with the plurality of branch instructions to improve branch prediction performed by the computing device.

What is claimed is:

1. A processor, comprising:
a processor optimization unit to:
collect runtime information associated with a computing device, wherein the runtime information comprises information indicating a performance of the computing device during program execution;
receive runtime optimization information for the computing device, wherein the runtime optimization information comprises information associated with one or more runtime optimizations for the computing device, and wherein the runtime optimization information is determined based on an analysis of the collected runtime information; and
perform the one or more runtime optimizations for the computing device based on the runtime optimization information.

2. The processor of claim 1, wherein the processor optimization unit to receive the runtime optimization information for the computing device is further to determine the runtime optimization information.

3. The processor of claim 2, wherein the runtime information comprises a plurality of event counters associated with a workload of the computing device.

4. The processor of claim 3, wherein the processor optimization unit to determine the runtime optimization information is further to perform phase recognition for the workload of the computing device.

5. The processor of claim 4, wherein the processor optimization unit to perform phase recognition for the workload of the computing device is further to perform noise reduction using soft-thresholding.

6. The processor of claim 4, wherein the processor optimization unit to perform phase recognition for the workload of the computing device is further to identify a phase associated with the workload using a convolutional phase comparison.

7. The processor of claim 4, wherein the processor optimization unit to perform phase recognition for the workload of the computing device is further to identify a phase associated with the workload using a chi-squared calculation.

8. The processor of claim 1, wherein the processor optimization unit to receive the runtime optimization information for the computing device is further to receive the runtime optimization information from a cloud service remote from the computing device.

9. The processor of claim 8:
wherein the runtime information comprises instruction trace data associated with an application executed on the computing device, wherein the instruction trace data comprises a plurality of branch instructions; and
wherein the runtime optimization information is determined by identifying a relationship associated with the plurality of branch instructions to improve branch prediction performed by the computing device.

10. At least one machine accessible storage medium having instructions stored thereon, the instructions, when executed on a machine, cause the machine to:
collect runtime information associated with a computing device, wherein the runtime information comprises information indicating a performance of the computing device during program execution;
receive runtime optimization information for the computing device, wherein the runtime optimization information comprises information associated with one or more runtime optimizations for the computing device, and wherein the runtime optimization information is determined based on an analysis of the collected runtime information; and
perform the one or more runtime optimizations for the computing device based on the runtime optimization information.

11. The storage medium of claim 10, wherein the instructions that cause the machine to receive the runtime optimization information for the computing device further cause the machine to determine the runtime optimization information.

12. The storage medium of claim 11:
wherein the runtime information comprises a plurality of event counters associated with a workload of the computing device; and
wherein the instructions that cause the machine to determine the runtime optimization information further cause the machine to perform phase recognition for the workload of the computing device.

13. The storage medium of claim 12, wherein the instructions that cause the machine to perform phase recognition for the workload of the computing device further cause the machine to perform noise reduction using soft-thresholding.

14. The storage medium of claim 12, wherein the instructions that cause the machine to perform phase recognition for the workload of the computing device further cause the machine to identify a phase associated with the workload using a convolutional phase comparison.

15. The storage medium of claim 12, wherein the instructions that cause the machine to perform phase recognition for the workload of the computing device further cause the machine to identify a phase associated with the workload using a chi-squared calculation.

16. The storage medium of claim 10:
wherein the runtime information comprises instruction trace data associated with an application executed on the computing device, wherein the instruction trace data comprises a plurality of branch instructions; and
wherein the runtime optimization information is determined by identifying a relationship associated with the plurality of branch instructions to improve branch prediction performed by the computing device.

17. A method, comprising:
collecting runtime information associated with a computing device, wherein the runtime information comprises information indicating a performance of the computing device during program execution;
receiving runtime optimization information for the computing device, wherein the runtime optimization information comprises information associated with one or more runtime optimizations for the computing device, and wherein the runtime optimization information is determined based on an analysis of the collected runtime information; and
performing the one or more runtime optimizations for the computing device based on the runtime optimization information.

18. The method of claim 17, wherein receiving the runtime optimization information for the computing device further comprises determining the runtime optimization information.

19. The method of claim 18:
wherein the runtime information comprises a plurality of event counters associated with a workload of the computing device; and
wherein determining the runtime optimization information comprises performing phase recognition for the workload of the computing device.

20. The method of claim 19, wherein performing phase recognition for the workload of the computing device comprises performing noise reduction using soft-thresholding.

21. The method of claim 19, wherein performing phase recognition for the workload of the computing device comprises identifying a phase associated with the workload using a convolutional phase comparison.

22. The method of claim 19, wherein performing phase recognition for the workload of the computing device comprises identifying a phase associated with the workload using a chi-squared calculation.

23. The method of claim 17:
wherein the runtime information comprises instruction trace data associated with an application executed on the computing device, wherein the instruction trace data comprises a plurality of branch instructions; and
wherein the runtime optimization information is determined by identifying a relationship associated with the plurality of branch instructions to improve branch prediction performed by the computing device.

24. A system, comprising:
a communication interface to communicate with a computing device over one or more networks; and
a plurality of processors for providing a cloud service for computer optimization, wherein the plurality of processors is to:
collect runtime information associated with the computing device, wherein the runtime information comprises information indicating a performance of the computing device during program execution;
determine runtime optimization information for the computing device, wherein the runtime optimization information comprises information associated with one or more runtime optimizations for the computing device, and wherein the runtime optimization information is determined based on an analysis of the collected runtime information; and
provide the runtime optimization information to the computing device to optimize performance of the computing device.

25. The system of claim 24:
wherein the runtime information comprises instruction trace data associated with an application executed on the computing device, wherein the instruction trace data comprises a plurality of branch instructions; and
wherein the plurality of processors to determine the runtime optimization information for the computing device is further to identify a relationship associated with the plurality of branch instructions to improve branch prediction performed by the computing device.
